(19) United States
(12) Patent Application Publication
(10) Pub. No.: US 2011/0106685 A1
(43) Pub. Date: May 5, 2011

(54) ISSUER-CONTROLLED MARKET PLATFORM AND SYSTEM FOR RESTRICTED HOLDINGS AND TRANSACTION MANAGEMENT

(75) Inventor: Barry Edward Silbert, New York, NY (US)

(73) Assignee: SECONDMARKET, INC., New York, NY (US)

(21) Appl. No.: 12/828,063

(22) Filed: Jun. 30, 2010

Related U.S. Application Data
(60) Provisional application No. 61/221,869, filed on Jun. 30, 2009.

(51) Int. Cl. G06Q 40/00

(52) U.S. Cl. 705/37

(57) ABSTRACT

An online environment configured to manage restricted holdings issued by an issuer and restrict access to a membership authorized by the first issuer. Through this online environment, an issuer such as a private company can organize a controlled private marketplace environment to manage trading, tracking and administration of securities and other financial instruments held in the private company by shareholders and other investors and financing sources.

### CROSS REFERENCE TO RELATED APPLICATION

This application claims the benefit under 35 USC 119(e) of U.S. Provisional Application No. 61/221,869, filed Jun. 30, 2009, the entirety of which is incorporated herein by reference.

### FIELD OF THE DISCLOSURE

The disclosure of the present application relates to an online financial marketplace, including a market platform controlled by an issuer for managing restricted financial instruments issued by the issuer and transactions therein.

### BACKGROUND

Unrestricted securities and interests that trade on public exchanges such as the NYSE or NASDAQ are able to be tracked, offered, priced and transferred in a relatively efficient manner due to a set of existing standardized and automated systems and processes, formed and operated by the relevant exchanges and market participants. Unfortunately, this is not the case for financial instruments that have restrictions on whether and how the financial instruments can be transferred. Such financial instruments are referred to in this disclosure as restricted holdings or illiquid assets.

There are generally two sets transfer restrictions—those codified in law and regulation (e.g., Rule 144 or Rule 4 explained below), and those set forth in an Issuer's own governing agreements (such as Bylaws, Shareholder Agreements, Investor Rights Agreements, etc.) and/or in the documentation through which the financial instrument was acquired (e.g., an option grant and exercise agreement, a purchase agreement, etc.). Some examples of the latter include an Issuer RoFR (Right of First Refusal), Investor RoFR and Co-Sale Rights.

Regarding an Issuer RoFR, many securities or other interests have a built in transfer restriction that provides for the transferor to give notice to the Issuer of the proposed sale and the material terms thereof, and then grants the Issuer or its assignee the right to purchase the securities or interests with some period of time (e.g., 30 days) on the same terms as the initial proposed transfer. This is generally present in transfers of private company securities.

An investor RoFR refers to a Right of First Refusal in favor of existing shareholders of the Issuer. For example, the Issuer can have a 30-day RoFR, and when it expires or is waived, certain shareholders can then have a RoFR for a period of time (e.g., 15 days). This is generally present in less than half of transfers of private company securities.

Co-Sale rights refer to another transfer restriction whereby certain existing shareholders of an Issuer have the right to participate within a certain period of time (e.g., 15 days) in a proposed transfer on the same terms and conditions as the prospective seller, thereby reducing the number of shares the seller is able to transfer. This is generally present in a small minority of transfers of private company securities.

Rule 144 or Rule 4 refers to commonly employed legal exemptions from registration under the Securities Act of 1933. For example, all secondary transfers (e.g., the transfer of sale of securities or interests in an Issuer from the holder to another non-Issuer person or entity) must take advantage of some exemption. Some stipulations provided include a holding period—Rule 144 pertains to buyers' status as an accredited investor, and both Rule 144 and 4 pertain to sophistication to make complicated investment decision and certain level of assets or income—and availability of certain information about the Issuer or the opportunity for the buyer to ask for it.

Issuers issue illiquid assets in private, primary offerings, in which the Issuer generally creates diligence and marketing materials, sometimes with the aid of a placement agent, and goes about sourcing potential investors through existing relationships or relationships of a placement agent. Often the Issuer also conducts primary issuances to employees and contractors wherein they grant options or shares as compensation.

The marketplace for the primary issuance of a particular Issuer's securities or interests is disjointed from the broader financial markets, from the Issuer's capitalization and compliance records and processes, from the sourcing of potential investors, from potential investors' bank and brokerage accounts, from investor diligence on the Issuer, from issuer diligence on the potential investor, from required legal and regulatory filings (such as a Form D), and from service providers involved in the offering.

The secondary market is even more disjointed as the Issuer is usually less involved. A holder of an illiquid asset who seeks to sell or otherwise transfer such holdings generally has two routes: wait for an Issuer coordinated buyback, which is generally rare, or independently locate a transferee, which is difficult for an employee with no ties to the financial industry and with buyers generally deterred from participating on secondary deals not formally sanctioned by the Issuer.

Consequently, the transfer of restricted holdings is an arduous process, exacerbated by the disaggregated nature of the broad marketplace for illiquid assets and the disjoint between the transfer participants (e.g., Issuer, Transfer Agent, buyers, sellers, existing investors, and applicable service providers such as attorneys).

### SUMMARY

An online environment (referred to in this disclosure as a MicroMarket) is disclosed that can manage restricted holdings issued by an issuer and restrict access to a membership authorized by the first issuer. Through this online environment, an issuer such as a private company can organize a controlled private marketplace environment to manage trading, tracking and administration of securities and other financial instruments held in the private company by shareholders and other investors and financing sources.

Such Issuer-specific sub-platforms (MicroMarkets) can, for example, maintain and display the market for interests in each Issuer, information on each Issuer, link to each participant's bank, brokerage and other accounts and to the services of relevant service providers such as attorneys and accountants, and navigate and automate the heretofore arduous process of effecting transfers of such interests. While the operation and automation of each MicroMarket improves the efficiency of conducting each transfer of illiquid assets and maintenance of an Issuer's capitalization table and other records, the integration of each MicroMarket within a broader platform for illiquid assets and within a network of many other sub-platform MicroMarkets improves the efficiency of accessing potential investors, accessing potential sellers, and the accuracy of the pricing of illiquid assets transferred therebetween.

The broader platform can comprise a secure, password-protected online platform providing users with the ability to research, list, bid on and transact in illiquid assets. The broader platform can be divided into sections according to asset type (e.g., private company securities, LP and investment fund interests, restricted public stock, auction rate securities, bankruptcy claims, mortgage-backed securities, asset-backed securities, collateralized debt obligations, whole loans, etc.). In each section a user can view the offers and bids on each position, market color with respect to each asset and certain information on the Issuers of the assets. Each user can maintain an account to track their holdings, custody their holdings, and transfer and receive funds. Users can list holdings for sale or bid on other listed holdings.

For example, a potential investor interested in a certain asset type or in a certain Issuer's interests may come across on the broad platform a different asset type of different Issuer for which such potential investor discovers an investment appetite. Through the link between each MicroMarket, the broad platform and the network of other MicroMarkets, this investor can proactively request to be given access to a MicroMarket of the newly discovered Issuer, and the administrator of such MicroMarket (i.e., the Issue or agent thereof) can grant access online. Similarly, a service provider (such as an attorney, accountant or broker) can also while browsing the broad platform request access to a MicroMarket to offer its competencies to the Issuer, to the MicroMarket members and/or to the MicroMarket process. Issuers can also refer members of their MicroMarket to other Issuers' MicroMarkets. Such requests and referrals can be effected by initiating an electronic message which would allow the recipient Issuer to confirm or deny online the referred party's access to their MicroMarket. Upon online approval of such access by the Issuer, an automated electronic message can be sent to the approved party with unique user ID and password information to access the newly joined MicroMarket. Thereby, each MicroMarket can maintain its own controlled environment while availing itself and its members in real time to new members, new sources of liquidity and new strategic partners.

### BRIEF DESCRIPTION OF THE DRAWINGS

FIG. 1 illustrates an example of a MicroMarket platform architecture.

FIG. 2 illustrates an example of a broader platform comprising a network of MicroMarkets.

FIG. 3 illustrates an example of a process for providing access to a MicroMarket.

FIG. 4 illustrates an example of a process for referring a member of one MicroMarket to another MicroMarket.

FIG. 5 illustrates an example of a process for tracking restriction events associated with restricted holdings in a MicroMarket.

FIG. 6 illustrates an example of a process for transferring restricted holdings in a MicroMarket.

FIGS. 7-25 illustrates examples of screens for configuring a MicroMarket.

FIGS. 26-46 illustrates examples of screens for using a MicroMarket.

FIG. 47 is an example of a hybrid offering.

FIG. 48 is a block diagram of an example of a basic computing device.

### DETAILED DESCRIPTION

The present disclosure is directed to an online environment (MicroMarket) that can manage restricted holdings issued by an issuer and restrict access to a membership authorized by the first issuer. Through this online environment, an issuer such as a private company can organize a controlled private marketplace environment to manage trading, tracking and administration of securities and other financial instruments held in the private company by shareholders and other investors and financing sources. The structure and function of the MicroMarket and its role amongst the broader financial markets automates and streamlines management of all types of restricted holdings.

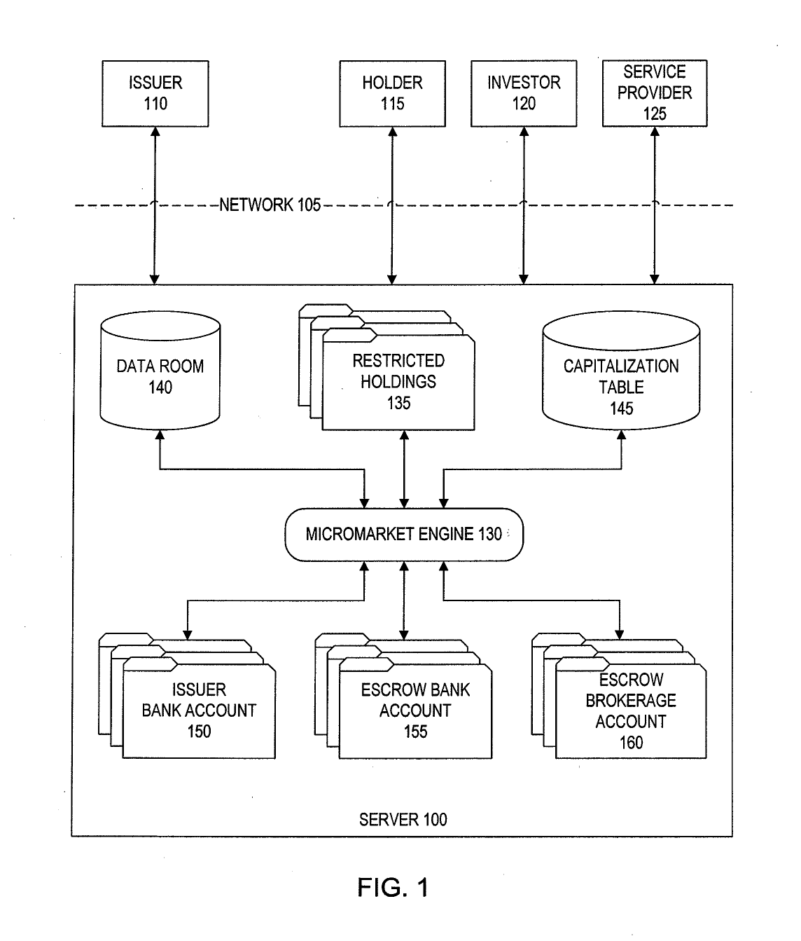

FIG. 1 illustrates an embodiment of a MicroMarket platform architecture. In the illustrated embodiment, server 100 deploys MicroMarket engine 130, which can be configured to provide an online environment (MicroMarket) to manage restricted holdings issued by an issuer. MicroMarket engine 130 can be coupled with data room 140, restricted holdings 135, capitalization table 145, issuer bank account 150, escrow bank account 155 and escrow brokerage account 160. Server 100 is accessible across network 105 to one or more client devices, such as, for example, issuer 110, holder 115, investor 120 and service provider 115. Issuer 110 can be operated by a user representing the issuer of restricted holdings 135. Holder 115 can be operated by a user representing a holder of one or more of restricted holdings 135. Investor 120 can be operated by a user representing an investor interested in acquiring one or more of restricted holdings 135. Service provider 115 can be operated by a service provider (e.g., an attorney) commissioned to facilitate the transfer of one or more of restricted holdings 135.

The MicroMarket provided by MicroMarket engine 130 can be set up for a specific Issuer and each holder of a realized interest (a holder of shares, for example). Each holder of a potential interest (a holder of an option to buy shares or other interest, for example) can be given password-protected access as a member. The MicroMarket can be administrated by the Issuer or its Transfer Agent, which may also grant access to certain service providers (attorneys, for example) and potential investors who they want to give the option to become an interest holder.

Online data room 140 can house diligence information (such as Board minutes or prospectuses), valuation data (such as a 409A) and other information given to members. Each time the Issuer or Transfer Agent adds new information to the data room, the MicroMarket can send an automated email to all permissioned members. Information can continue to also be available online.

The MicroMarket can maintain capitalization table 145 of the Issuer to keep track of all who hold beneficial interests in the Issuer. The MicroMarket can be tied to bank account 150 in the name of the Issuer, escrow bank account 155 for conducting members' transfers through, and escrow brokerage account 160 for the potential custody of each member's securities or interests (including option and warrant agreements) in the Issuer and for carrying out the non-monetary component of member transactions.

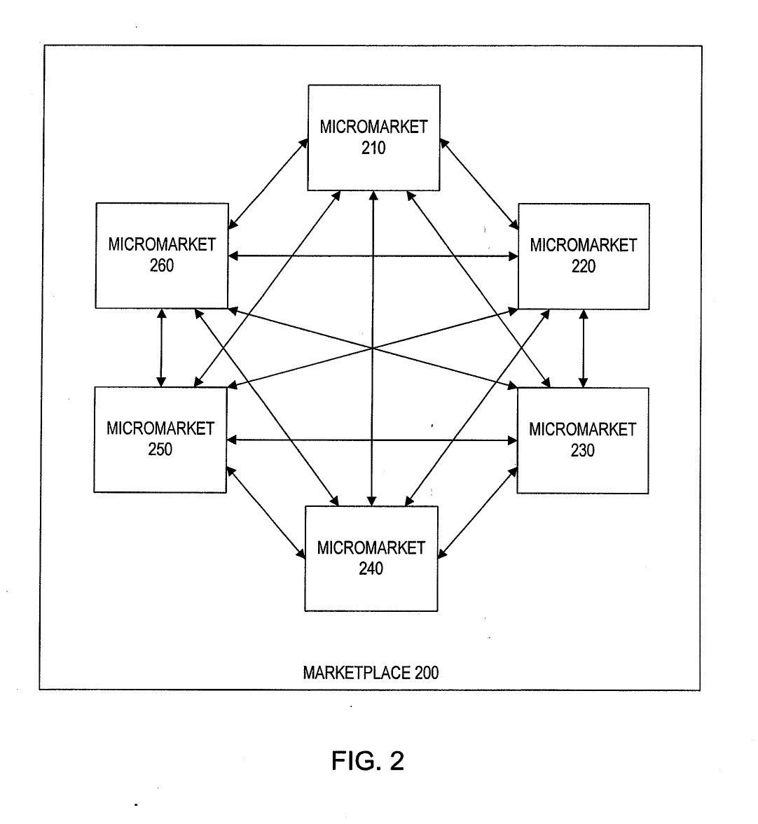

FIG. 2 illustrates an example of a broader platform comprising a network of MicroMarkets. While the operation and automation of MicroMarket 210 (provided by MicroMarket engine 130) can improve the efficiency of conducting each transfer of illiquid assets and maintenance of the Issuer's capitalization table and other records, the integration of MicroMarket 210 within a broader platform (marketplace 200) for illiquid assets and within a network of many other sub-platform MicroMarkets 220, 230, 240, 250 and 260 improves the efficiency of accessing potential investors, accessing potential sellers, and the accuracy of the pricing of illiquid assets transferred therebetween.

Marketplace 200 can comprise a secure, password-protected online platform providing users with the ability to research, list, bid on and transact in illiquid assets. Marketplace 200 can be deployed by server 100 or another server in coordination with server 100. This broader platform can be divided into sections according to asset type (e.g., private company securities, LP and investment fund interests, restricted public stock, auction rate securities, bankruptcy claims, mortgage-backed securities, asset-backed securities, collateralized debt obligations, whole loans, etc.). In each section a user can view the offers and bids on each position, market color with respect to each asset and certain information on the Issuers of the assets. Users can list holdings for sale or bid on other listed holdings. Each user can maintain an account to track their holdings, custody their holdings, and transfer and receive funds. The broader platform allows each member to set up their own bank and brokerage accounts (or link to external ones), and such accounts can be linked to those of each MicroMarket the member is part of so that transfers of funds and securities can be automated and otherwise done efficiently and safely.

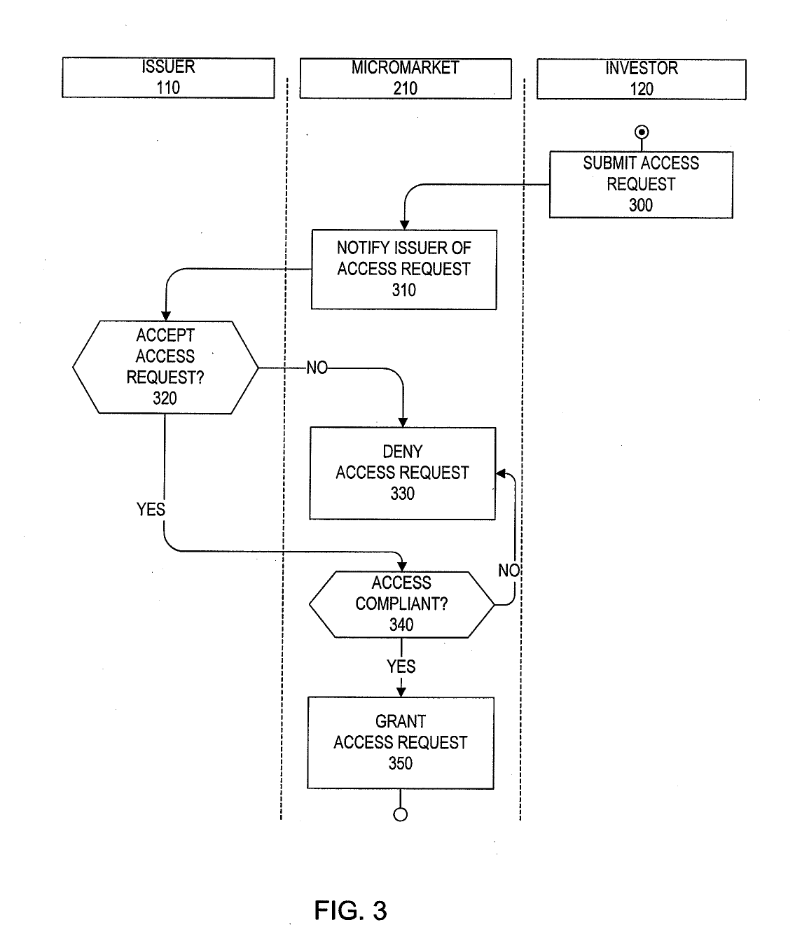

FIG. 3 illustrates an example of a process for providing access to a MicroMarket. In the illustrated embodiment, an investor operating investor 120 or any other user can submit an access request (block 300) to MicroMarket 210. The request can take any suitable form, such as clicking on an indication of interest in marketplace 200 for example. Upon receipt of the access request, MicroMarket 210 can notify (block 310) the issuer associated with the MicroMarket of the access request. The issuer can consider the whether to accept or deny the access request in MicroMarket 210. If the issuer denies the request, MicroMarket 210 can receive an indication of denial of the access request by the issuer and implements the denial of the request (block 330), such as by notifying the requestor that the request has been denied. If the issuer accepts the request, MicroMarket 210 can receive an indication of acceptance of the access request by the issuer, and perform a compliance check (block 340) on the requestor to determine whether the requestor complies with one or more conditions associated with membership to the first online environment.

For example, before a new member is given access, the MicroMarket can prompt the administrator to run any applicable compliance checks such as Anti-Money Laundering, etc. To the extent that relevant database feeds (like the U.S. Treasury's Office of Foreign Asset Control or certain background check services) are available in real time, the MicroMarket can automatically cross-reference such feeds in conjunction with such checks, before access is granted. The compliance check can be performed to the extent that such a check has not already been run as part of access to the broader platform, since it is likely that the broader platform in which the MicroMarket is housed has already run such checks in addition to any checks of accreditation/buyer status. However an Issuer may implement other checks for its MicroMarket, such as only non-individual entities or only residents of California, that are more narrow than those for the broad platform.

If the compliance check fails, MicroMarket 210 can implement the denial of the request (block 330). If the compliance check passes, MicroMarket 210 can implement the granting of the access request (block 350), in which an automated electronic message can be sent to the approved party with unique user ID and password information to access the newly joined MicroMarket.

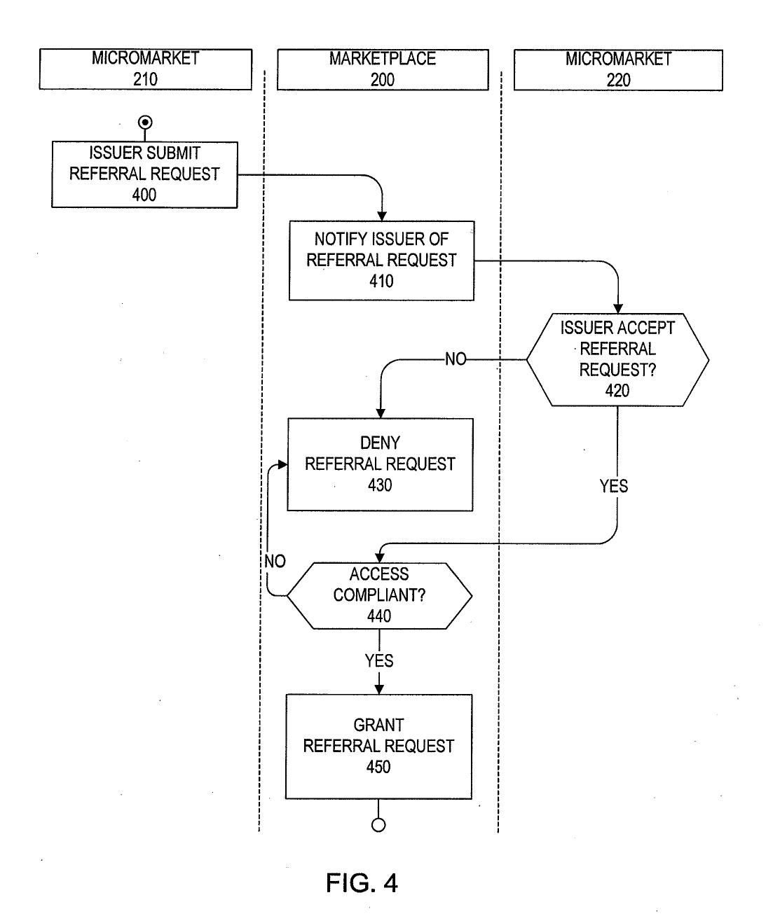

FIG. 4 illustrates an example of a process in which Issuers can also refer members of their MicroMarket to other Issuers' MicroMarkets. In the illustrated embodiment, such requests and referrals can be effected by the Issuer associated with MicroMarket 210 initiating an electronic message (block 400) provided by the broader platform (block 410) which would allow the recipient Issuer associated with MicroMarket 220 to confirm or deny online (block 420) the referred party's access to their MicroMarket. Upon denial of online approval of such access by the Issuer or failing of the appropriate compliance check as described above, the MicroMarket can implement the denial of the request (block 440). Upon online approval of such access by the Issuer and appropriate compliance check as described above (block 440), a notification such as an automated electronic message can be sent (block 450) to the approved party with, for example, unique user ID and password information to access the newly joined MicroMarket. Thereby, each MicroMarket can maintain its own controlled environment while availing itself and its members in real time to new members, new sources of liquidity and new strategic partners.

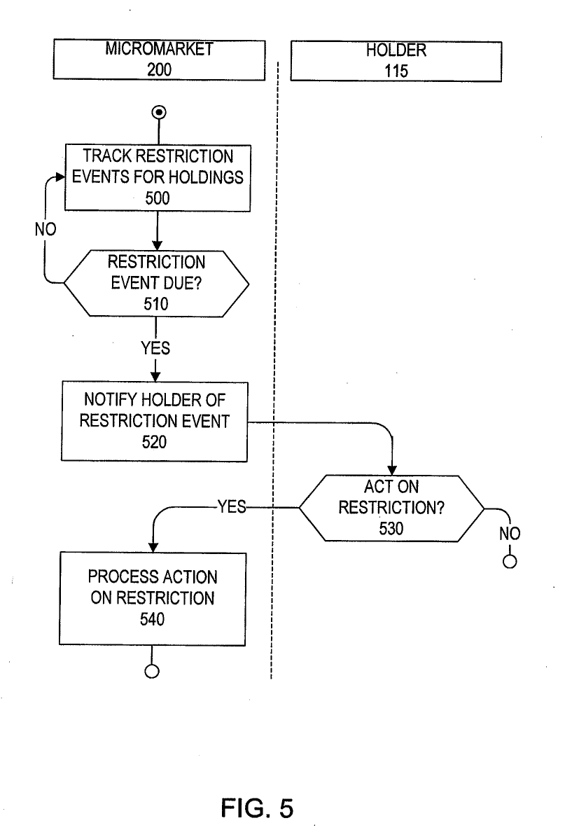

FIG. 5 illustrates an example of a process for tracking restriction events associated with restricted holdings in a MicroMarket. In the illustrated embodiment, the MicroMarket can track (block 500) restriction events for holdings, such as vesting of options and warrants, and exercise and expiration schedules for example. When the restriction event is due (block 510), notification, such as automated email alerts, can be transmitted (block 520) to members. For example, the e-mail alert can be transmitted with option/warrant holdings when expiration of the option/warrant nears and when vesting occurs. Holders, such as option/warrant holders, can be given the ability to act (block 530) on these restrictions, such as by exercising their options/warrants into shares via online automated processes. These processes can use transfer management functions such as automated bank and brokerage account linkage, automated online distribution, execution and collection of standardized agreements, and real time management of the Issuer's capitalization table and records for example.

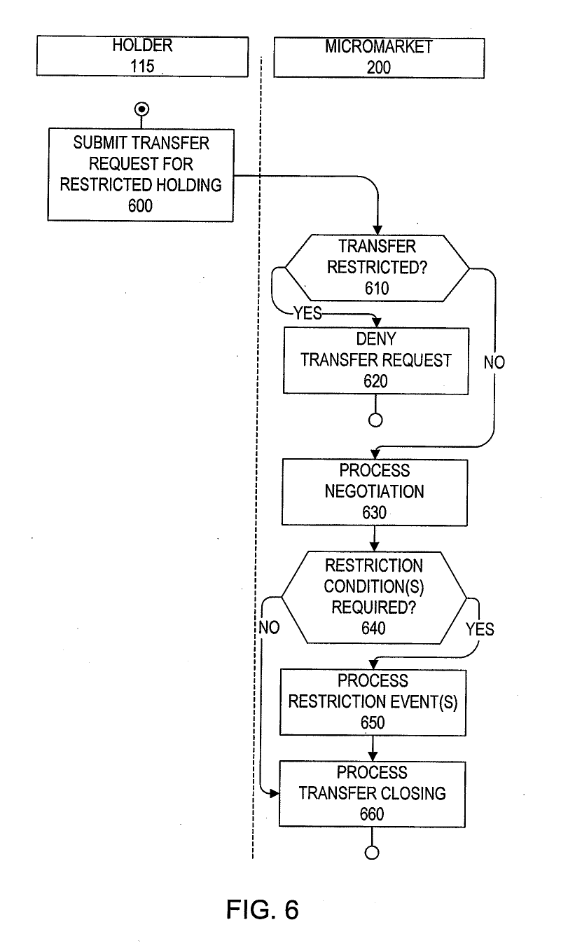

FIG. 6 illustrates an example of a process for transferring restricted holdings in a MicroMarket. In the illustrated embodiment, in response to a holder submitting a transfer request for a restricted holding (block 600) to the MicroMarket, the MicroMarket can determine (block 610) whether any restriction associated with the restricted holding prohibits the transfer. If a restriction associated with the restricted holding prohibits the transfer, the MicroMarket can deny the transfer request (block 620) and notify the holder of the error. If no restriction associated with the restricted holding prohibits the transfer, the MicroMarket can process the transfer request. This processing can include processing a negotiation (block 630), determining whether a restriction condition like a RoFR and/or Co-Sale is required (block 640), processing the restriction event (block 650) if such a restriction condition is required, and process the closing of the transfer (block 660).

An example of 1) an option grant to 2) an exercise of option into shares to 3) a secondary transfer can further illustrate the functionality described above. In particular, what follows is a description of the functionality of the MicroMarket by taking an example of a former employee who is granted an option to buy shares, has that option vest, exercises that option into shares and then proceeds to transfer a portion of those shares. This example assumes that a 30 day Issuer RoFR, a 15 day Investor RoFR, and a 15 day Co-Sale apply to the transfer of any shares. The word Issuer is used in the processes, but if the Issuer has deputized a third party to serve as a Transfer Agent, then certain references to the Issuer (such as administrative tasks of receiving notices and processing paperwork and evidence of ownership—but not substantive rights such as RoFR) are intended to apply instead to the Transfer Agent.

Suppose a former employee is given, as compensation, an option to buy 100k shares of the Issuer which vests in two half parts on an annual basis and expires in two and one-half years. This holding can be tracked in the MicroMarket (and in the former employee MicroMarket member's own platform account) including all relevant details such as strike price to buy the shares, expiration of the option, vesting schedule, etc. At first the tracking can show an unvested option to buy 100k shares. In one year's time, the tracking can be updated to show a vested option to buy 50k shares and an unvested component for 50k shares. An automated alert can be sent to the member and the MicroMarket administrator of the same. Again, on the second year, the tracking can be updated to show a fully vested option to buy 100k shares and again an automated alert can be generated to the member and the administrator. As the date of the option's expiration approaches, the member and the administrator can be periodically (with increasing frequency) sent automated messages as to this fact.

At any time, the member can log in (which can automatically log him into the broad platform and each MicroMarket in which he is a member) and view the status of his holdings in his platform account. By clicking on his holdings in this particular Issuer, he can be automatically directed to a more detailed view that can takes him inside of the actual Issuer's MicroMarket. Upon seeing his option holding status, he can be given the ability, for any set of vested options, to exercise such options online. To do so, the member can click on the appropriate link next to the vested position. He can then be given (online and/or via email for example) the exercise/purchase agreement which he can execute with a click agreement online or via an electronic signature service for example. Upon such execution, the member can be instructed that the next step for him is to deposit the exercise price and relevant taxes into the Issuer's MicroMarket bank account. Because the member has the ability to create a platform bank account (or link to an outside bank account), the member can initiate the transfer of funds in the same online platform session. Upon receipt of the appropriate amount into the Issuer's account, an automated notice can be sent to the member and to the Issuer which can also include the previously executed exercise/purchase agreement for the Issuer's countersignature, which the Issuer can complete online just as the member did. Upon completion of this final step, notice of the effective exercise if sent to the member and to the Issuer, the member's holdings can be updated in real time to reflect a lesser number of options and a greater number of shares, the Issuer's capitalization table and other records can be automatically updated in real time. Both the holdings of a member and the capitalization table can include, for each position, a list of the relevant transfer restriction in data form along with cross-reference to the authoritative instrument instituting such restriction. A share certificate or other evidence of ownership can be auto-populated into an electronic document which can then be sent to the Issuer for signature, after which the certificate can be deposited into the linked escrowed custody account and a copy sent to the member. After “receipt” by the escrowed account of the certificate, the holder's funds in the escrow bank account can be sent out to the Issuer, and if the Issuer so chooses, can be delineated into two wires, one to the Issuer for the proceeds and one into a separate account for the taxes.

After a period of time, suppose the member desires to sell some of his shares. To do so, he can go to view his holdings in the broader platform and select the Issuer's interests or may go directly to the MicroMarket. Next to his position in shares he can select them for sale and indicate the quantity to offer and an asking price. Before listing the shares for sale in the MicroMarket, the MicroMarket can cross-reference the relevant transfer restrictions associated with the position. If some transfer restriction does not allow for the listing or the sale of such shares at that time, an error message can be generated online alerting the member to this fact and providing an explanation. For example, it could be the case that these shares are non-transferable for some reason, or that the Issuer has set up its MicroMarket to only allow sale of shares that have been held at least one year and only allows members to list such shares within one month of this one year time period. If the shares can be listed and sold, then the position can be listed in the market section of the MicroMarket with the specified quantity and ask price which can be viewable to all permissioned members. Simultaneously the member's holdings can be updated to reflect that this portion of his shares are offered to be sold. An automatically generated notice of the listing can be sent to all MicroMarket members and the Issuer. It is noted that a seller may choose to forgo a listing and instead choose an auction which the MicroMarket can incorporate into its process.

A potential buyer who is a member may come across this listing and can place a bid on it either above, at or below the asking price. An Issuer can choose a setting wherein buyers can only bid on positions if their platform bank account has the requisite funds or they may not require it. An automatically generated notice of this bid can be sent to all MicroMarket members and the Issuer. The potential seller can choose to either affirm the bid or decline the bid. If he declines then notice of the same can be automatically generated and sent to the bidder. The history of all asks and bids and transaction details can be stored and accessible by the Issuer and other authorized persons. If he affirms then there can be a price match and buyer, seller and Issuer can be notified. The listing in the market section of the MicroMarket can no longer be an open listing but its status can be denoted as a price match and further bidding may not be possible if the Issuer sets its settings as such. The seller's holdings can also be updated to reflect that the listed shares are now in a state of negotiation.

Then, purchase and sale agreements, transfer materials and instructions can be automatically generated and populated with buyer and seller details, (which can be given upon becoming a member) and transaction details, and such items can be automatically sent to the buyer and the seller, who can execute online with a click agreement or through an electronic signature service for example. Upon execution by both sides, the purchase/sale/escrow agreements can be distributed to buyer, seller and Issuer (which can also receive a formal notice letter of the transfer and the signed transfer materials). It is noted that the actual transfer materials (Stock powers, etc.) can not be made available to any of the seller's counterparties until proof of funds into escrow is confirmed. The Issuer has 30 days to exercise its RoFR and can be alerted to this fact by way of an automated alert.

If the Issuer (or its assignee) does exercise then they enter as such on the MicroMarket. In this case, the buyer and seller can be alerted via automated message and their transaction can be terminated. New purchase/sale/escrow and transfer documents with the Issuer as the buyer can be generated and sent to seller and Issuer for execution after which all materials can be distributed online.

If the Issuer does not exercise, then once the 30 day Issuer RoFR period expires or is waived, a notice letter can be formally sent to seller, buyer, Issuer and all investors holding the Investor ROFR who have 15 days to exercise. Just as in the case of an Issuer exercise, if any or all investors do exercise they can note as such on the platform by responding to the letter and all parties can be notified via online alert, new purchase/sale/escrow and transfer documents can be generated and populated per the amended transaction details and disseminated to the seller, buyer(s) and Issuer. Note that the MicroMarket allows for the Issuer and Investors with RoFR or Co-Sale rights to establish a setting whereby they can automate their responses to proposed transfer notices. For example, an Issuer can activate a setting which, in response to any proposed transfer notice (or any notice above or below a certain quantity of shares and above or below a certain share price), automatically respond with an electronic message notifying the relevant parties of their intention to exercise (or waive) their RoFR rights. Such setting can be de-activated at any time. The same automated decision making setting can be made available to investors with RoFR and Co-Sale rights as well.

If neither the Issuer RoFR nor the Investor RoFR is exercised, then a formal notice letter can be generated by the MicroMarket and sent to seller, buyer, Issuer and all Investors holding a Co-Sale right which shall extend for 15 days. If any or all investors do exercise their Co-Sale, they can note as such on the platform by responding to the letter and all parties can be notified via online alert, new purchase/sale/escrow and transfer documents can be generated and populated per the amended transaction details and disseminated to the seller, buyer(s) and Issuer.

Once the RoFR and Co-Sale are navigated, then the deal can move to closing. As per the above, all of the purchase/sale/escrow and transfer documentation is already executed and in the hands of the Issuer (and the transfer documents can be held in a virtual escrow by the MicroMarket). It may be the case that this Issuer requires an opinion of independent counsel stating that the transfer is exempt from registration under the Securities Act of 1933. If this is the case, the seller can be given an alert that this is the next step and such alert (or the view of the transaction status) can suggest the seller hire certain approved MicroMarket service provider attorneys. The seller can select any one of the recommended attorneys and in turn the documentation required by such attorney to be signed by the seller can be automatically generated and sent to the seller. A notice of the same can be sent to the attorney. If the attorney would like to chat with the seller they can do so by messaging in the MicroMarket or may choose more traditional means. Once the attorney has everything he requires, the attorney can alert the MicroMarket of it and the MicroMarket can automatically generate and populate the attorney's form opinion which can then be sent to the attorney for electronic signature. After signature, the opinion can be sent to the seller, the buyer the attorney and the Issuer.

At this point, the buyer may need to pay the purchase price. It may be the case that the Issuer only wants to conduct transactions where funds are deposited into the Issuer escrow account before the process begins (which may be less necessary if the Issuer already has the setting that no bids can be placed unless adequate funds are in the bidder's platform bank account), or may be the seller demanded as such. If that were the case then the purchase price can be automatically transferred from the buyer's platform bank account upon execution of the purchase/sale agreements. If that was not the case, then the money can be transferred at this point to the Issuer escrow account. Upon the funds hitting such account a notice can be sent to the seller, buyer and Issuer and any transfer materials that were held in virtual escrow can be released to all parties as well. The MicroMarket can now confirm that all agreements, documents, opinions and funds are in place and this can trigger the transfer to be effected. The issuer's capitalization table and records, the seller's holdings, and the buyer's holdings can all be updated. The listing in the market section can be closed out and moved to a past transaction (before this point the listing could have been noted as in the closing and settlement phase—dependent on whether the Issuer determines it wants past and pending deals to continue to be accessible). The seller's old certificate or evidence of ownership can be cancelled and new certificates for the buyer and seller (if shares remain) can be automatically generated by the MicroMarket into an electronic document which can then be sent to the Issuer for signature, after which the certificate can be deposited into the linked escrowed custody account and a copy sent to the member. Upon “receipt” of the escrow account of the new certificates, the escrow account can be triggered to initiate all the wires as set forth in the escrow agreement which can send a payment to the utilized attorney who wrote the opinion, a wire to the Issuer if there is a processing fee, a wire to any broker as allowed by the Issuer and applicable, and the proceeds of the sale to the seller. All can possess platform bank accounts or outside accounts linked to the platform. Upon release and receipt of all the wires, each relevant platform bank account or linked account can confirm such receipt and send notice to the seller, buyer and Issuer. Upon receipt of all wires and notice thereof, the sale can be deemed officially closed and the MicroMarket can generate and distribute to buyer, seller and Issuer (and any counsel or brokers involved) a transaction confirmation ticket and summary, affirming the closing and presented a timeline and history of the deal.

Note that throughout the process, in addition to the auto-generated alerts that can be rendered upon reaching each milestone in the transfer, a buyer or seller (or Issuer or investor with RoFR or Co-Sale rights) can log on at any time to the MicroMarket and view their holdings and therewithin the status of each of their pending deals (or for the Issuer all pending deals, and for the investors with RoFR or Co-Sale rights, status of deals affecting them). Such status can note that the deal is in the 30 day Issuer RoFR, or 15 day Investor RoFR or 15 day Investor Co-Sale, or waiting for opinion or closing or settling, etc., and such status can also be shown in terms of a transaction timeline showing all steps completed and those to be done and timeframe for completion.

Also note that the legal and regulatory concerns addressed above by way of Rule 144 or Rule 4 exemptions can be varied depending on the asset type. For example, if the asset was an investment fund interest and the Issuer was a partnership, then the MicroMarket can be set up to adhere to the transfer requirements of operating a Qualified Matching Service under Treasury Regulation section 1.7704-1(g) to avoid the Issuer being treated and taxed as a publicly traded partnership.

In connection with primary Issuances, Issuer's can also utilize the MicroMarket to conduct a primary issuance of securities or interests. Keep in mind that the permissions for accessing and participating in the sections of the MicroMarket devoted to primary issuances can be distinct from those for the Issuer's secondary market.

The process can begin with the Issuer (and its agents such as brokers, placement agents, attorneys, etc.) loading onto their MicroMarket diligence and market documentation. The Issuer can then initiate an electronic message alerting and explaining of the primary issuance to all or some current MicroMarket members as well as members of the broader platform (which can be invited to join the MicroMarket and the section thereof for the primary issuance).

After a period of time during which participants can diligence the Issuer and its new issuance of securities and interests, the price and quantity of the issuance can be sent via electronic message to the Issuer and all primary participants. Such price and quantity can be set by the Issuer, determined via a demand-side bidding process or auction, or some combination thereof, and can be variable with minimum and maximum limits set. Either through a demand-side bidding process or auction or simple ask/bid process, prospective investors can indicate online their desire to purchase some of the offered securities.

The Issuer can be sent a notice of each prospective investors interest and can accept or deny. If the Issuer denies, notice of the same can be sent to the prospective investor. If the Issuer accepts, notice can be sent to the prospective investor and purchase and subscription agreements can be generated by the MicroMarket and sent electronically to the participating investors for execution online or via electronic signature service. Upon the investor's execution, the partially executed document can be sent to the Issuer. Upon the Issuer's countersignature the MicroMarket can send notice of the same to the investor and funds can be automatically transferred from the investor's platform bank account to the Issuer's account. Upon the confirmation by the Issuer's platform account of receipt of such funds, notice can be sent to Issuer and investor along with the fully executed purchase and subscription agreements.

The Issuer's capitalization table and records can be updated, the investors' holding records can be updated, and share certificates or other evidence of ownership can be generated and populated and sent to Issuer for execution. Upon such execution, the hard copy can be held by the Issuer in escrow and electronic form can be sent to the investors. Once this process is complete for all participating investors, the MicroMarket can autogenerate for the Issuer certain regulatory filings selected such as a Form D and send it to the Issuer for execution and filing.

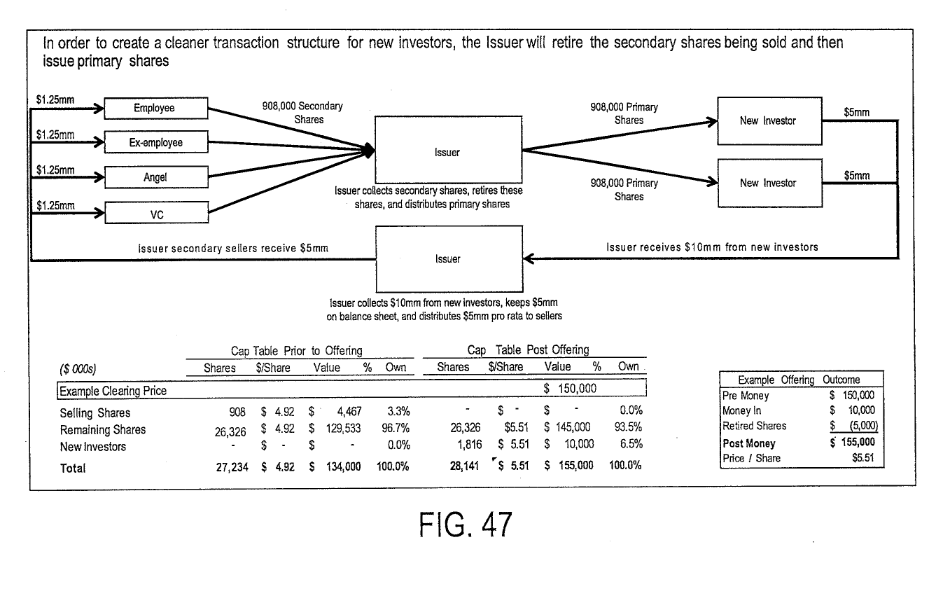

In connection with hybrid offerings (primary offering combined with secondary transfer or Issuer buyback), an Issuer can choose to allow existing shareholders to sell into the offering. The quantity and share price of the offering can be determined by the Issuer, by a sell-side driven listing or auction or a buy-side driven bidding or auction for example. Sellers and buyers can elect to participate online after receiving an electronic notice of the offering, and at what quantity (and at what price if through a non-fixed mechanism). After final prices, quantities and participants are determined, then notice of the each participants outcome and confirmation of the deal can be sent via electronic means. There can be two iterations of the remainder of the process, (i) if there is a primary offering to buyers from the Issuer coupled with an Issuer buyback from the sellers—that is when the Issuer sells shares to buyers and then uses all or part of the proceeds to buy back shares from existing shareholders, and (ii) the other for a primary offering coupled with secondary transfers from sellers to buyers—that is the Issuer sells shares to buyers who also are buying direct from existing shareholders. Though there can be many legal, regulatory and business consideration to take into account in choosing between these two, from a workflow perspective they can be the same, albeit with different forms of agreements to execute. See FIG. 47 for an example of the second route.

Buyers can be sent purchase and subscriptions agreements by electronic means and sellers can be sent purchase and transfer documents. Both buyers and sellers can be prompted to execute such documentation online or via other electronic means. Upon such execution the purchase and subscription documentation can be transmitted to the Issuer for counter-signature and the transfer documentation can be held in a virtual escrow (e.g., not accessible until proof of receipt of purchase price funds into escrow). Upon Issuer's execution, funds from the buyers' platform bank accounts can be transferred to a MicroMarket escrow bank account. Upon the funds hitting that account, notice can be sent to all parties and the transfer documents can be released from virtual escrow and disseminated, along with the Issuer's countersigned purchase and transfer documents to the seller and subscription documents to the buyer, to all parties as well.

The MicroMarket can then cancel the electronic version of the proof of ownership of the seller's shares just transferred and send notice to the Issuer to destroy the original. New certificates or proof of ownership can be generated by the MicroMarket and populated with the buyers' holdings. A virtual copy can be stored in the Issuer's virtual escrow account and the Issuer can be prompted to sign a hard copy for custody—a copy of which can be sent to the buyer. The Issuer's capitalization table and records can be updated, as can the buyers and sellers' holdings.

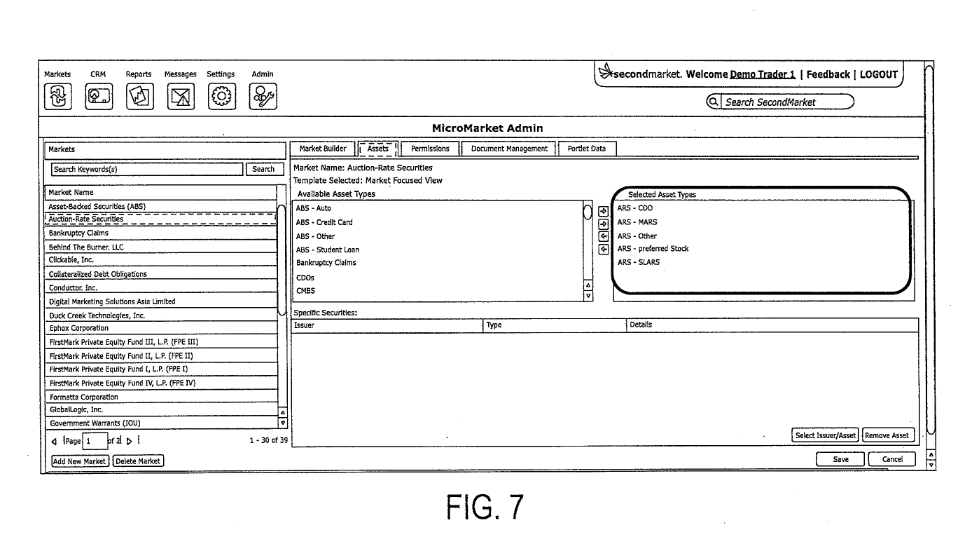

FIGS. 7-25 illustrates examples of screens for configuring a MicroMarket. For example, the system of the broader platform enables a user to configure any Market. Market configuration can include four main parts:

1. What can be traded at the market

2. Who has permission to trade on the market

3. How the securities can be traded (trading models)

4. How market shall be presented to end user

In connection with what can be traded at the market, market admin can define list of securities that are allowed for trade by:
either selecting Asset Types (e.g. Private Company Common Stocks, Bankruptcy Claims, etc), or
by selecting some specific securities (e.g. Facebook Common Stock, LinkedIn Warrant, etc.).

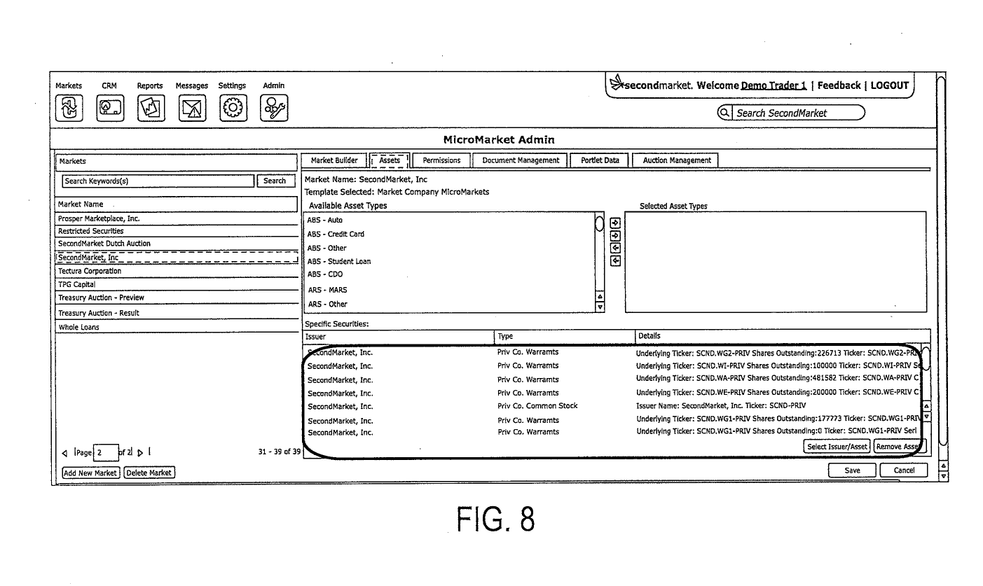

FIG. 7 illustrates configuring market securities by asset type. FIG. 8 illustrates configuring market securities by selecting individual securities.

To be able to exclude some specific securities from general markets (that can be configured by Asset Type), security master provides the ability to configure for each security places where security can be traded. There can be two options for this:
Any Market (default value)—security can be traded at any market, that is configured with Asset Type or with Security
Specific Market—security can be traded only on those markets that has this specific security selected

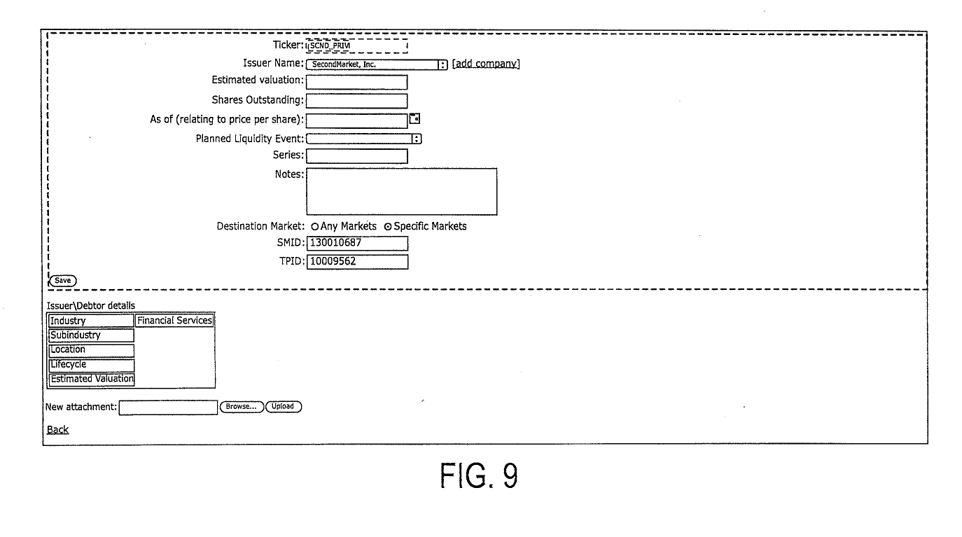

FIG. 9 illustrates configuring security for specific market (in SecMaster)

The system allows to configure markets with the mix of asset types and specific securities or to allow trading of security on multiple markets. Individual securities can be used to configure MicroMarkets (markets that are configured to facilitate trade for some particular company of institution) while Asset Types can be used to define general markets that trade securities of some set of related asset types (e.g. Private Companies Securities, or ARSB) that are not covered by MicroMarkets.

In connection with who has permission to trade on the market, the system allows to configure permissions on the market using permission scheme and role assignment. Permission scheme allows assigning permissions to the roles without indicating users.

To configure permission scheme system has the following list of predefine roles:
Administrator
Company Executive
Employee
Guest
Investor
Major Shareholder
Shareholder
SM Market Specialist

Each role can be granted multiple permissions. System supports the following permissions:
View Market Tearsheet—user is able to navigate to market portlet
View Listings—user is allowed to view listings on particular market
CRUD Listings (CRUD stands for Create/Read/Update/Delete)—user is allowed to create and manage listings
CRUD Bids—user is allowed to create and manage bids
Access Command Center—user can manage market settings
Access Reports—reserved for future use

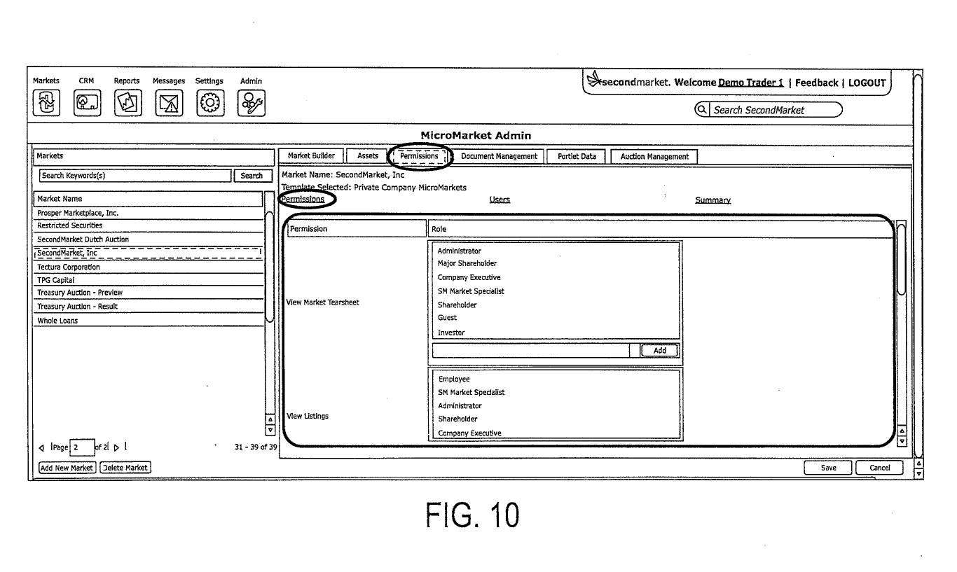

FIG. 10 illustrates configuring permission scheme. Once permission scheme is configured admin can assign users to roles. When assigning user to the role, user gets all permissions associated with the role. User can be assigned to more than one role.

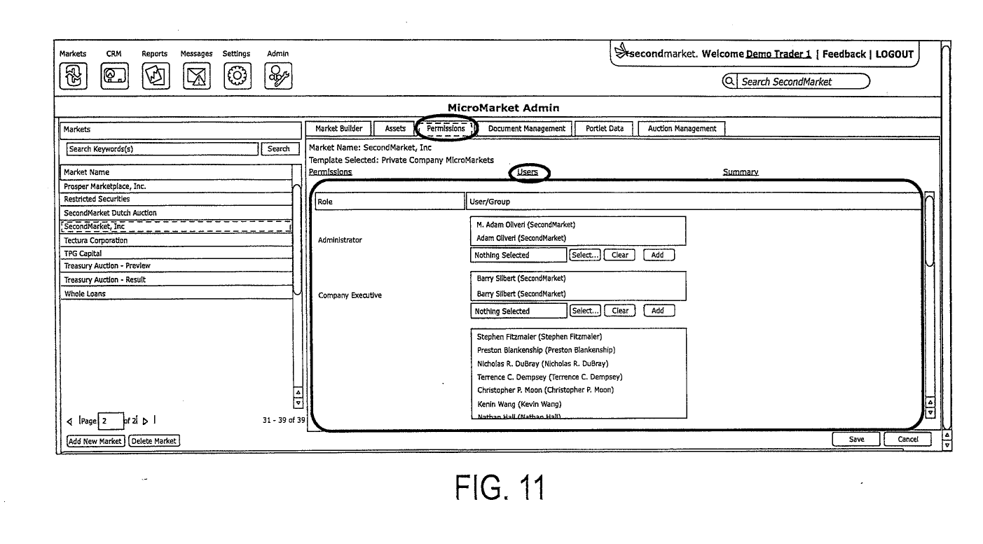

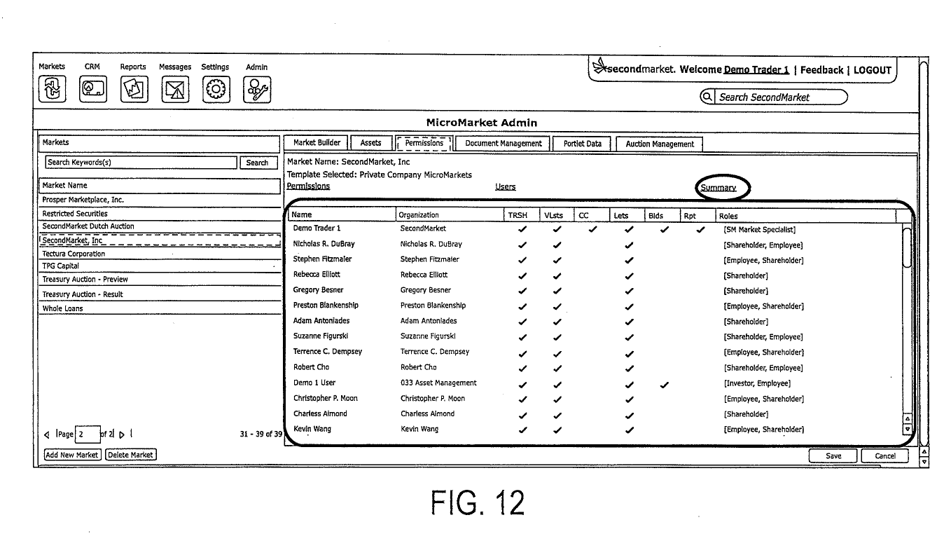

FIG. 11 illustrates assigning users to permissions. Admin can doublecheck user's permissions using Summary Tab. FIG. 12 illustrates permission summary.

In connection with how the securities can be traded (trading models), Admin can select type of tradings that users are allowed to use for listings. The platform can support the following trading models:
Static Listing
English Auction
Manhattan Auction
Sealed Bid Auction
Dutch Auction

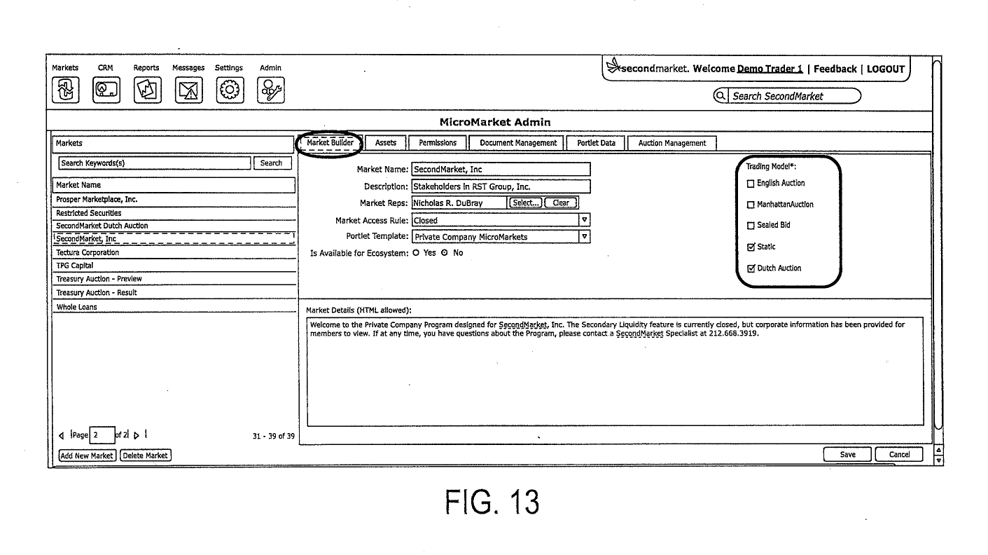

FIG. 13 illustrates configuring trading models.

In connection with how market shall be presented to platform user, there can be at least four templates of portlets that specify how market can be presented to platform users:
Market Focused View
Private Company MicroMarket
LP MicroMarket
Dutch Auction

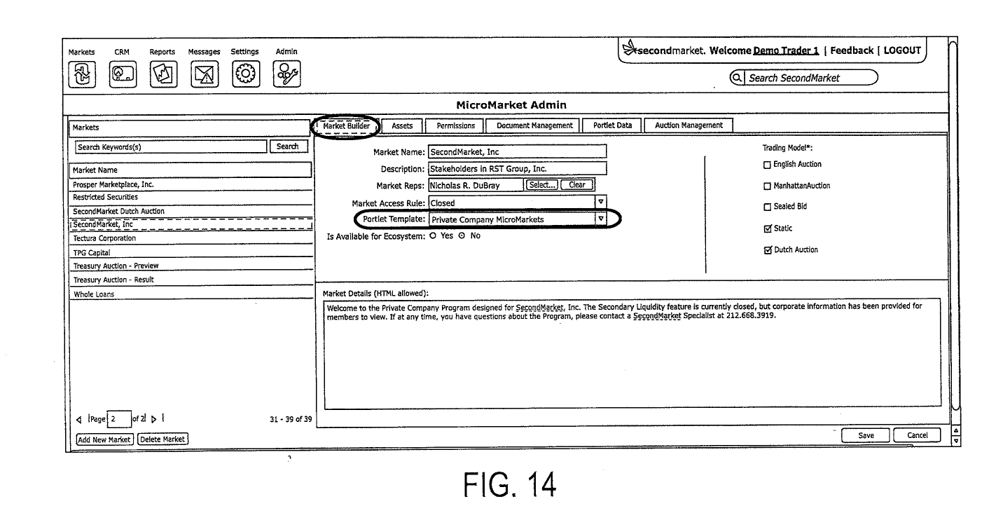

FIG. 14 illustrates configuring portlet template.

Market Focused View template can be used for general markets. It can aggregate market listings, market research data, ecosystems and micromarkets. For traders this template can additionally display additional portlets with data filtered by market.

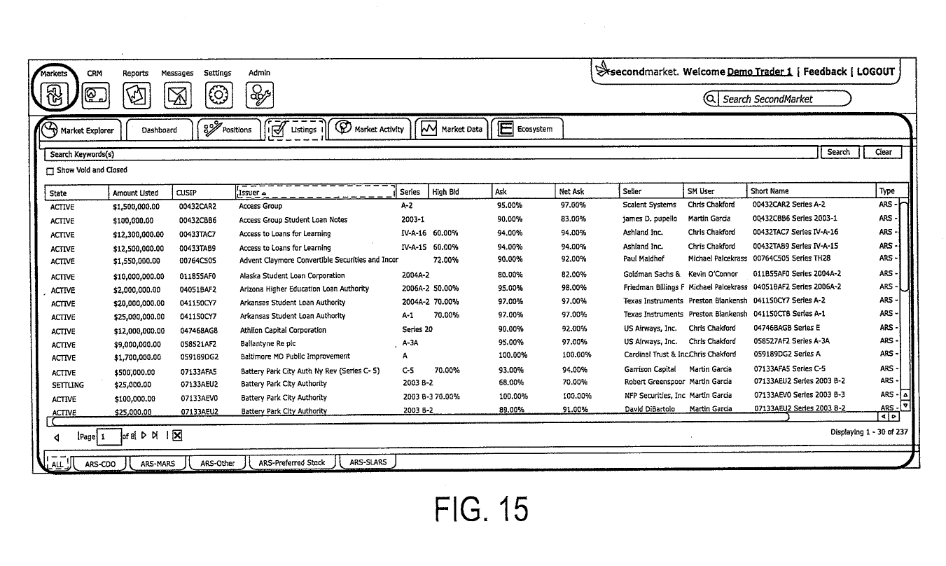

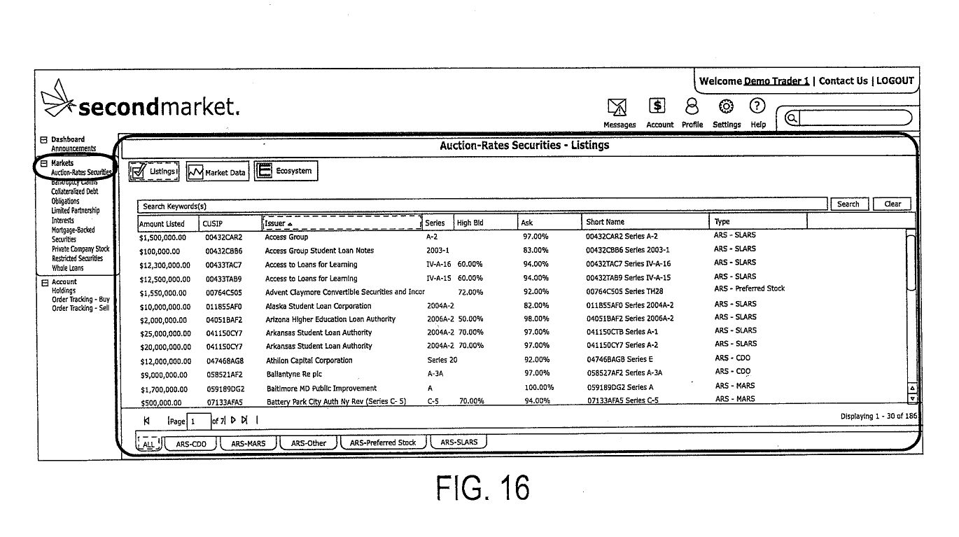

User can navigate to portlets with Market Focused View Template using Markets section in top (for traders) or left side (for Members) navigation. FIG. 15 illustrates Market Focused View for ARS Market for Trader. FIG. 16 illustrates Market Focused View for ARM Market for Member.

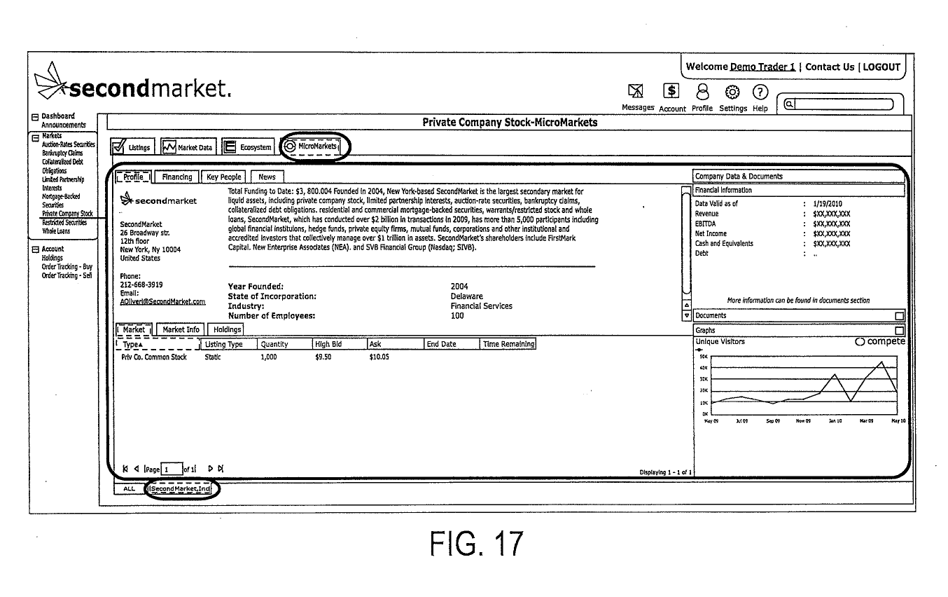

Private Company MicroMarket portlet can display information about Private Company in addition to standard trading info. So users have ability to learn about private company, study due diligence materials before trading private company securities on this company micromarket. FIG. 17 illustrates Private Company MicroMarket Portlet for Second Market MicroMarket.

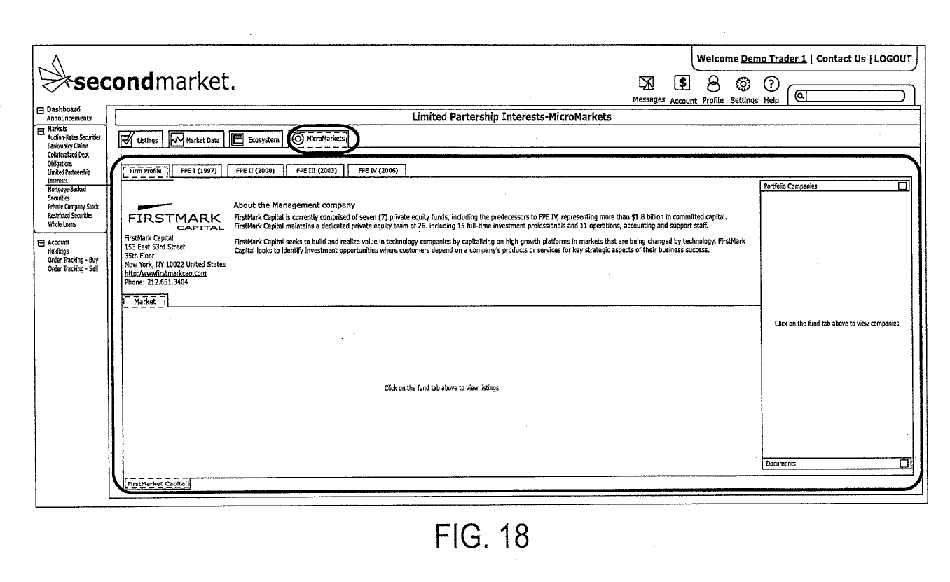

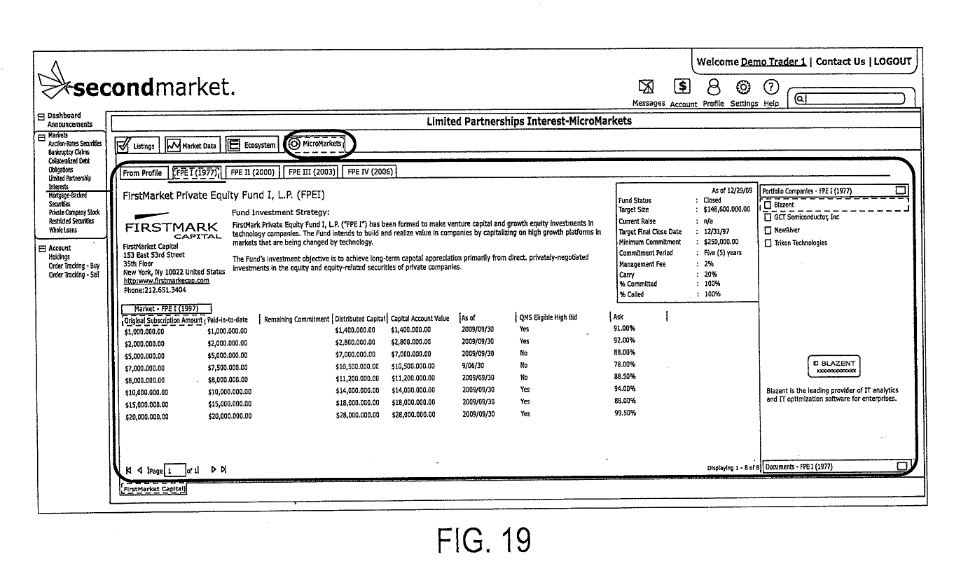

LP MicroMarket displays information about Management Firm and LP Fund in addition to standard trading info. This template can be slightly different from Private Company MicroMarket as it can present different due-diligence information (specific to LPs) as well as displays set of micromarkets of the same management firm. FIG. 18 illustrates LP MicroMarket Portlet for FirstMark Capital Firm (Firm Tab). FIG. 19 illustrates LP MicroMarket Portlet for FirstMark Capital FPE I Fund (FPE I tab).

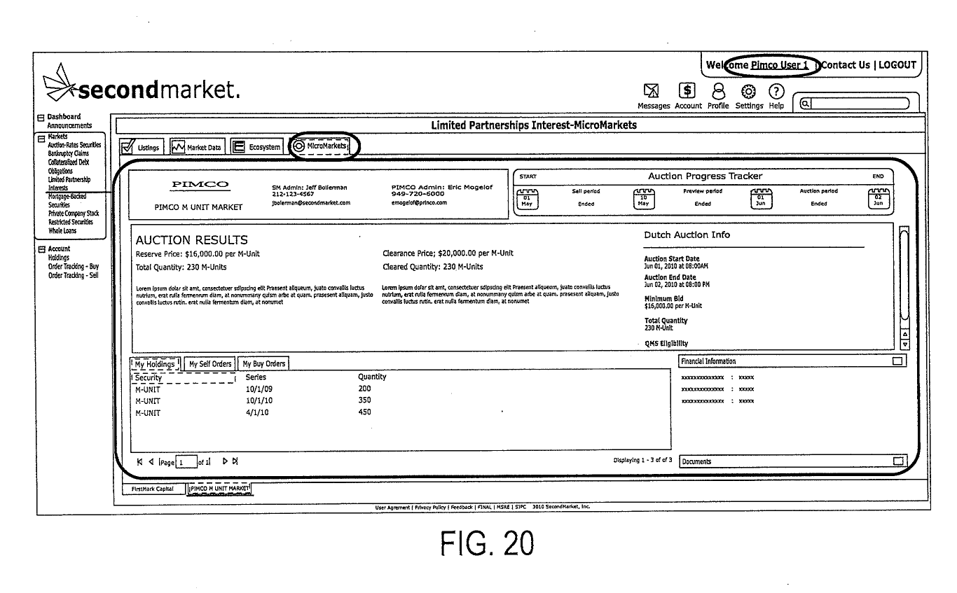

Dutch Auction template can be designed to conduct Dutch Auctions. So when market is configured to be presented as Dutch Auction, only information relevant to current Dutch Auction can be displayed. FIG. 20 illustrates Dutch Auction template for PIMCO Micromarket.

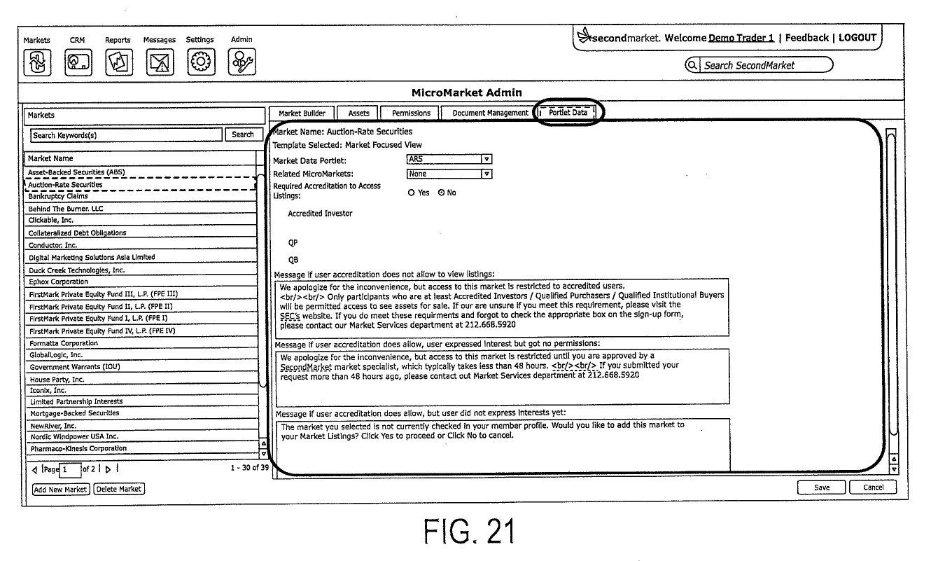

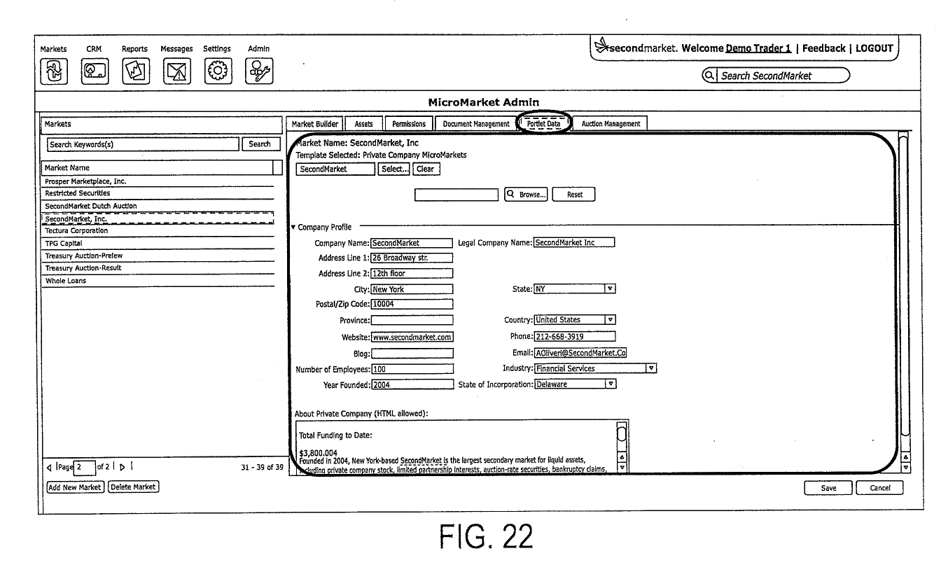

Based on the selected MicroMarket template admin can configure data required by template. This can be done in Market Admin/Portlet Data tab that depends on the selected template. FIG. 21 illustrates Portlet Data for ARS Market (with Market Focused View template). FIG. 22 illustrates Portlet Data for SecondMarket MicroMarket (with Private Company MicroMarket template).

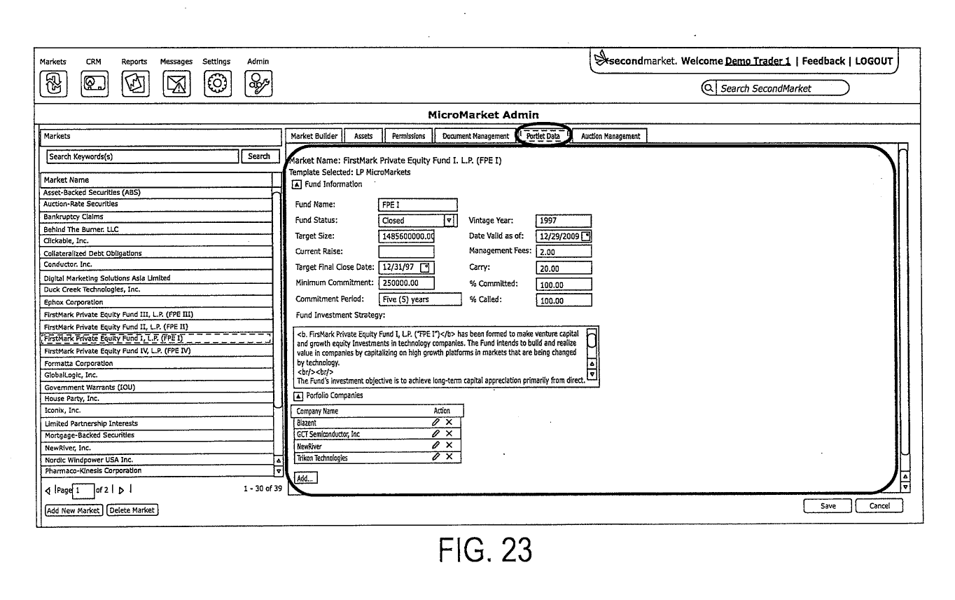

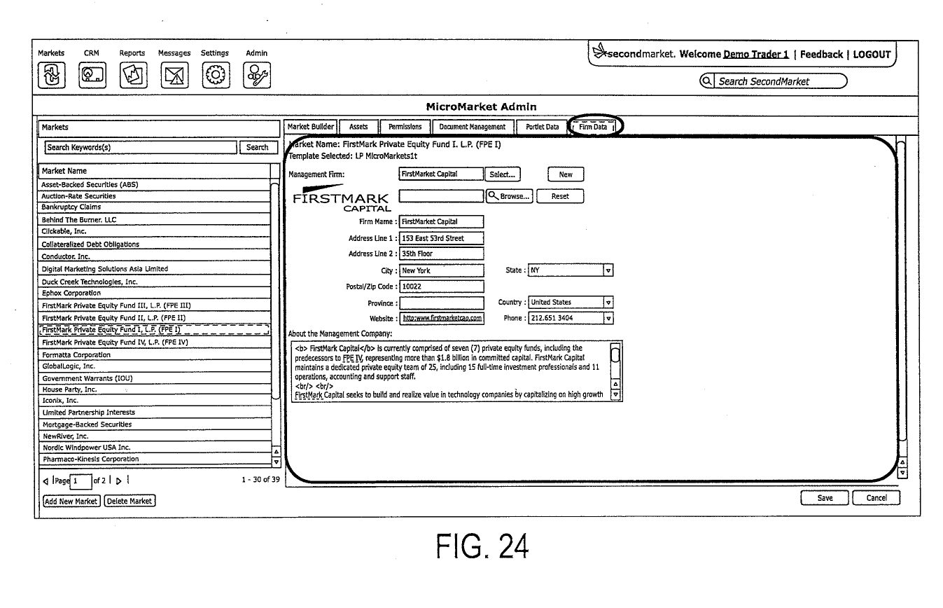

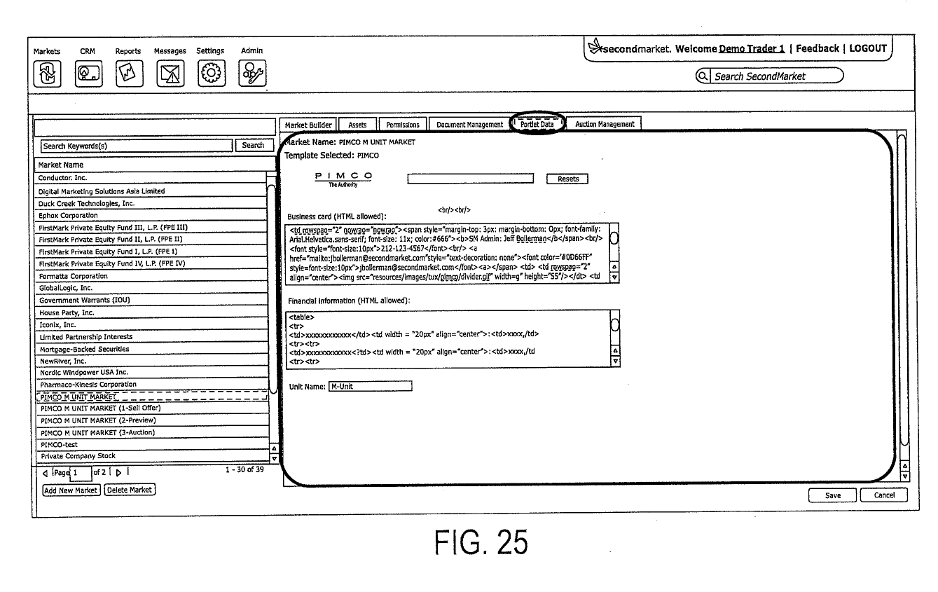

For LP template admin shall configure both Portlet Data (for current market) as well as Management Firm Data (Management Firm info that is shared between Fund's MicroMarkets of the same management firm). FIG. 23 illustrates Portlet Data for FirstMark PE I Fund (with LP MicroMarket template). FIG. 24 illustrates Firm Data for FirstMark PE I Fund (with LP MicroMarket template). FIG. 25 illustrates Portlet Data for PIMCO M-Units market (with Dutch Auction template).

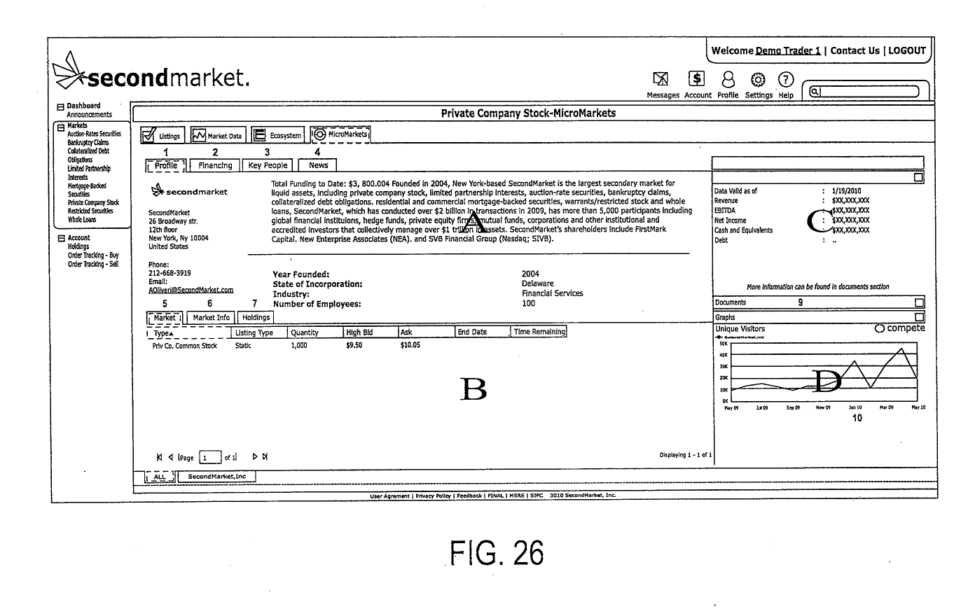

FIGS. 26-46 illustrates examples of screens for using a MicroMarket. For example, Private Company MicroMarket Portlet can consists of four Major parts:
A—general company information, which is grouped in four tabs (Profile, Financing, Key People, News)
B—Market information—market listings, market rules, user's holdings that can be listed on micromarket.
C—due diligence materials, which include documents and key financial figures
D—statistics graphs from 3rd party providers

FIG. 26 illustrates Private Company MicroMarket Portlet structure. Data for sections A, B (Market Info only), C, and D can be sourced from two sources:
Market Settings
Private Company Tearsheets

Private Company Tearsheets can be Research Market Data that can be maintained outside TUX platform and can include general company information. This data can be used to populate private company micromarket portlet as well. All information (that is needed to display portlet) can be managed directly in market settings. In the illustrated embodiment, some of the information can be managed in market settings, and some can be sourced from private company tearsheets.

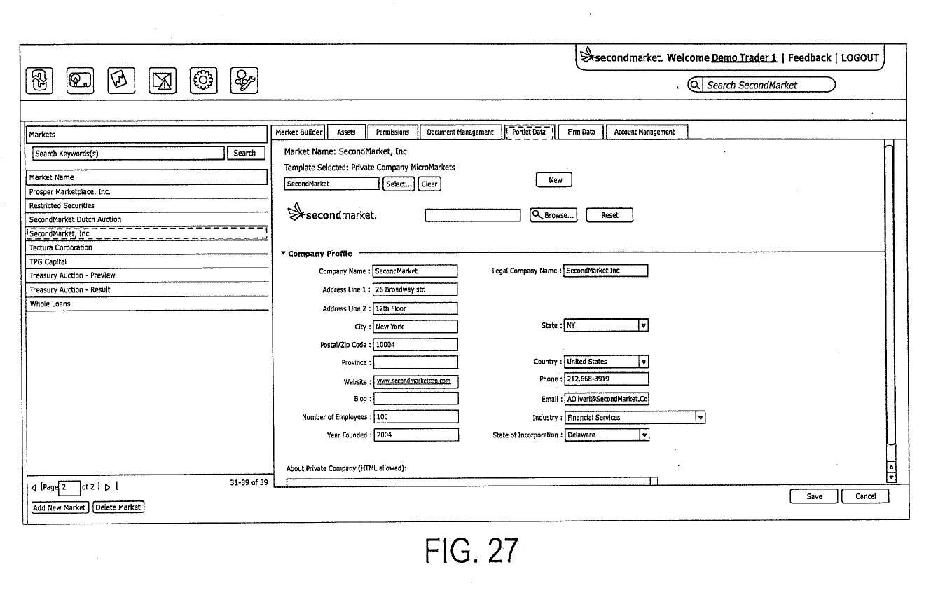

Market Settings allows to manage Company Profile data (tab 1) that includes logo, address, contact information, brief description, and key facts (year founded, state of incorporation, industry, number of employees. FIG. 27 illustrates Market Setting for Private Company MicroMarket.

As the part of market settings market admin can also configure tearsheet that can be used to source data.

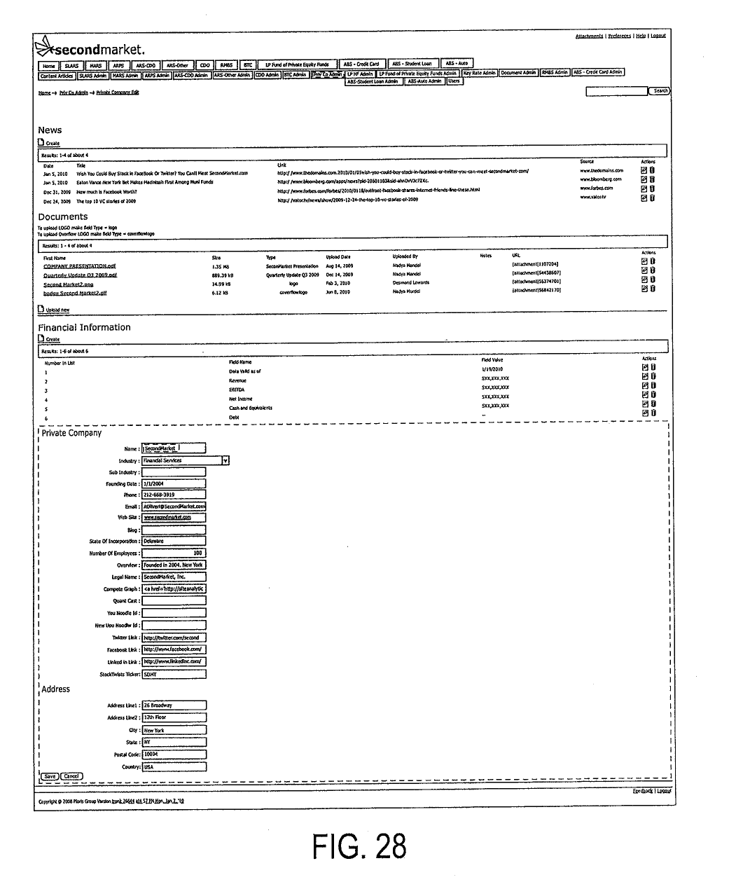

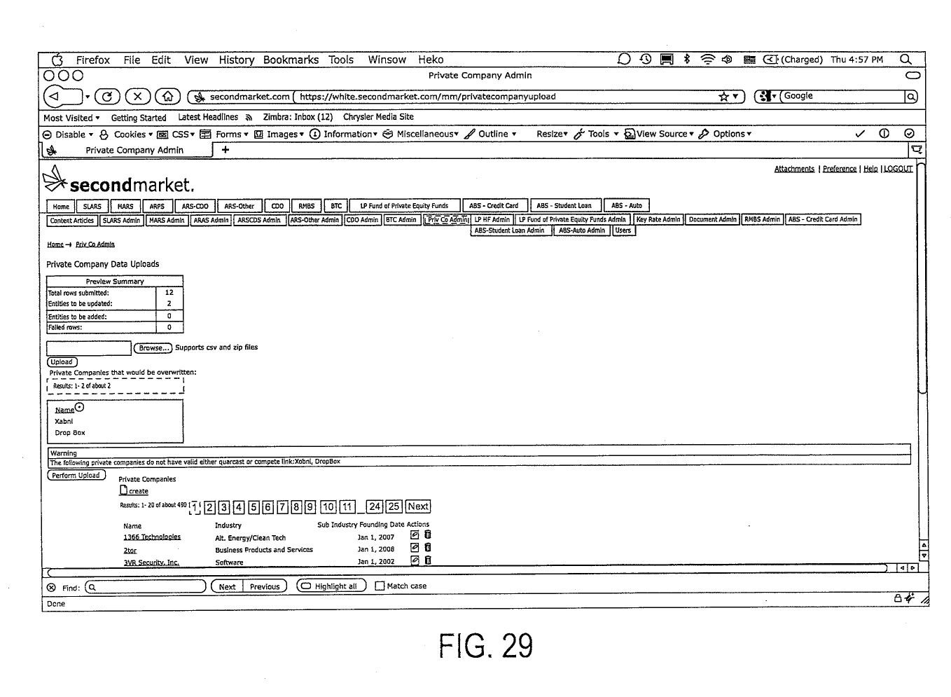

Tearsheet data can be managed in different application (white.secondmarket.com/mm). MicroMarket (MM) allows to manage part of the fields from user interface (FIG. 28) and all fields by importing xls spreadsheet (FIG. 29). FIG. 28 illustrates Private Company Tearsheet Data Management through MM tool. FIG. 29 illustrates Private Company Tearsheet Data Management through MM spreadsheet importer.

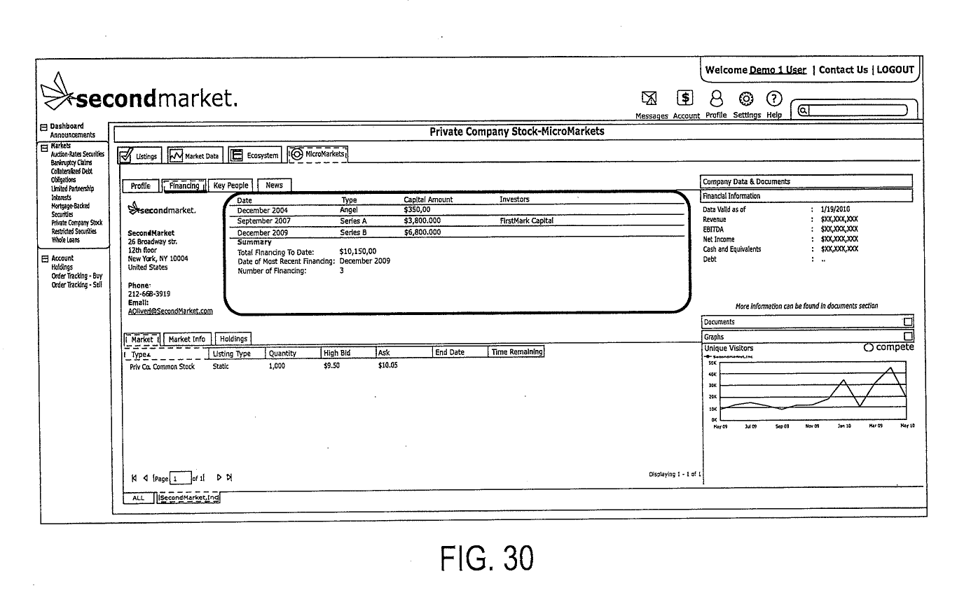

Financing tab (tab 2) displays rounds of financings. It can include table with Date, Type, Capital Amount and Investors as well as some summary information, such as Total Financing to Date, Date of Most Recent Financing, Number of Financing. Company Financing Data can be managed through spreadsheet upload in MM tool (FIG. 29). This data can be manageable from Market Settings. FIG. 30 illustrates Financing Tab in Private Company MicroMarket portlet.

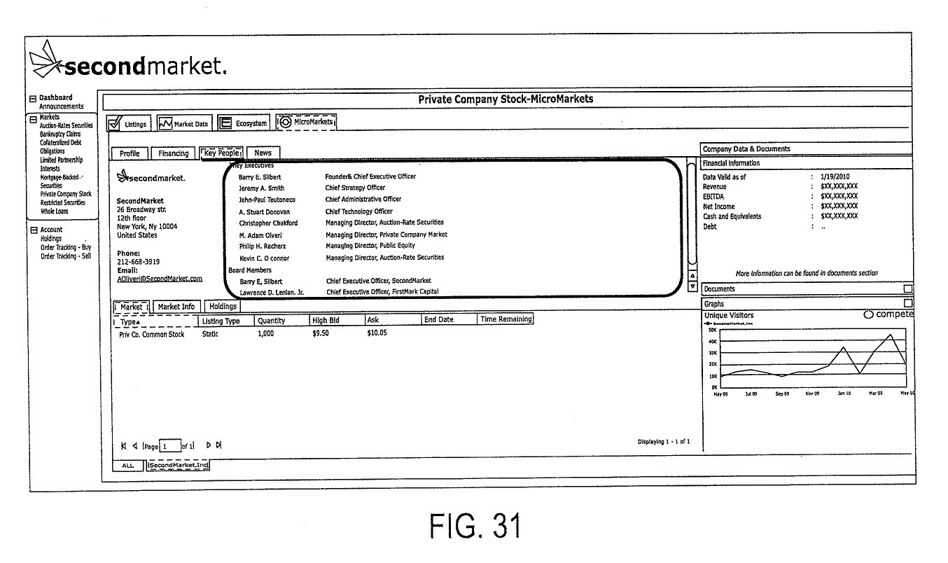

Key People section (tab 3) displays list of key people. Key people can be grouped into three groups—Key Executives, Board Members and Advisors. Information can include people name and position. The same as financing, Key People can be managed through spreadsheet upload in MM tool (FIG. 29). This data can be manageable from Market Settings and can include more data, such as photo, contact info, etc. FIG. 31 illustrates Key People Tab in Private Company MicroMarket.

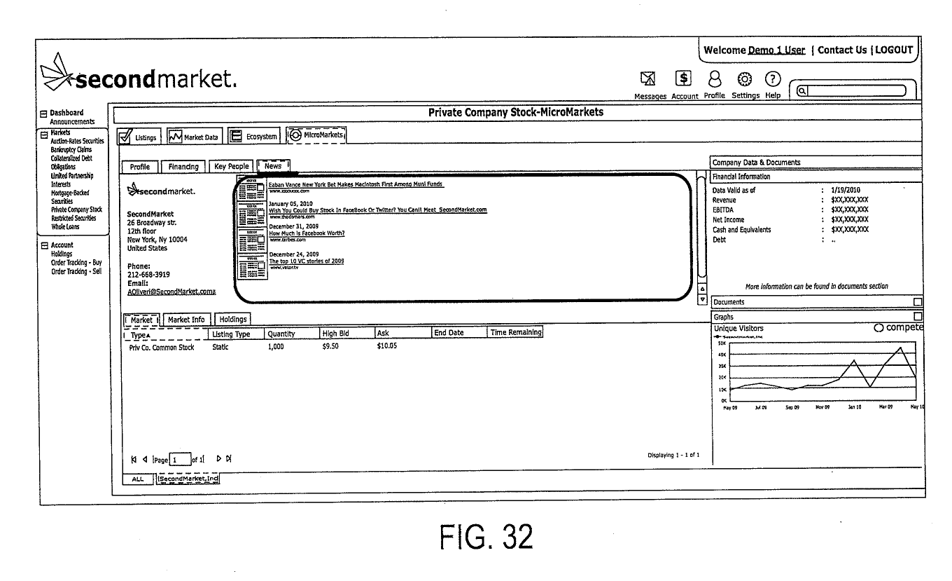

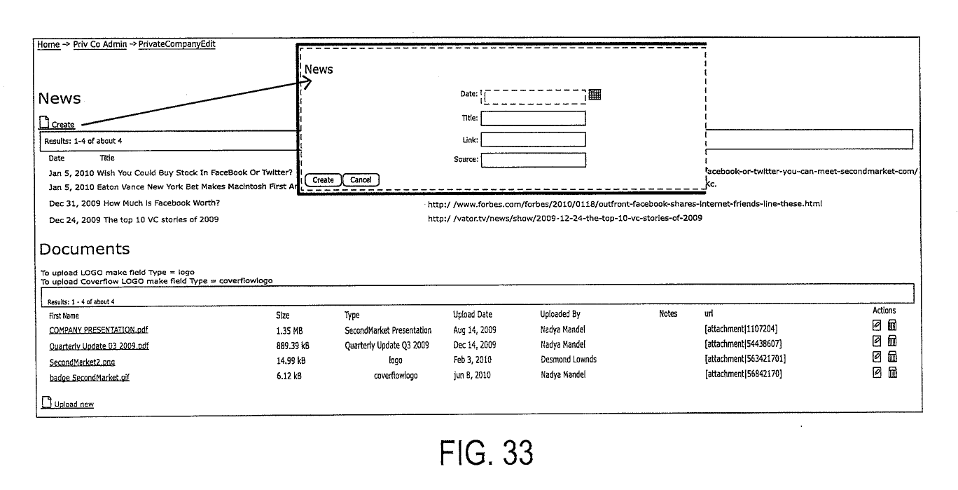

News section (tab 4) displays news links. News can be managed from MM (FIG. 33). This data can be manageable from Market Settings and include more data, such as news picture, link to external news and allow to submit text for internal news. FIG. 32 illustrates News Tab in Private Company MicroMarket. FIG. 33 illustrates Management of News from MM.

Section B groups Market Info. It includes:
Market—grid with listings for private company micromarket
Market Info—trading rules for micromarket
Holding—user's holdings that can be listed on micromarket

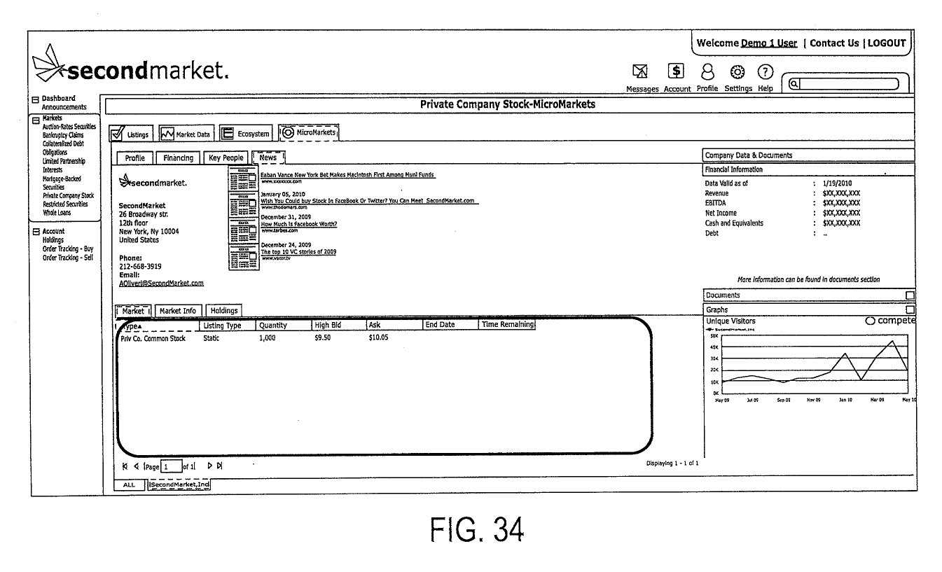

Market tab displays (tab 5) active listing on micromarket. Member can use this grid to place bids. FIG. 34 illustrates MicroMarket Listings.

Market Info tab (tab 6) displays trading rules imposed by current private company micromarket. Market Info can consists of at least two parts:
Market Rules—free form text that market admin can mange from market settings
Market Parameters—autogenerated section based on market settings. This section displays trading models selected from micromarket.

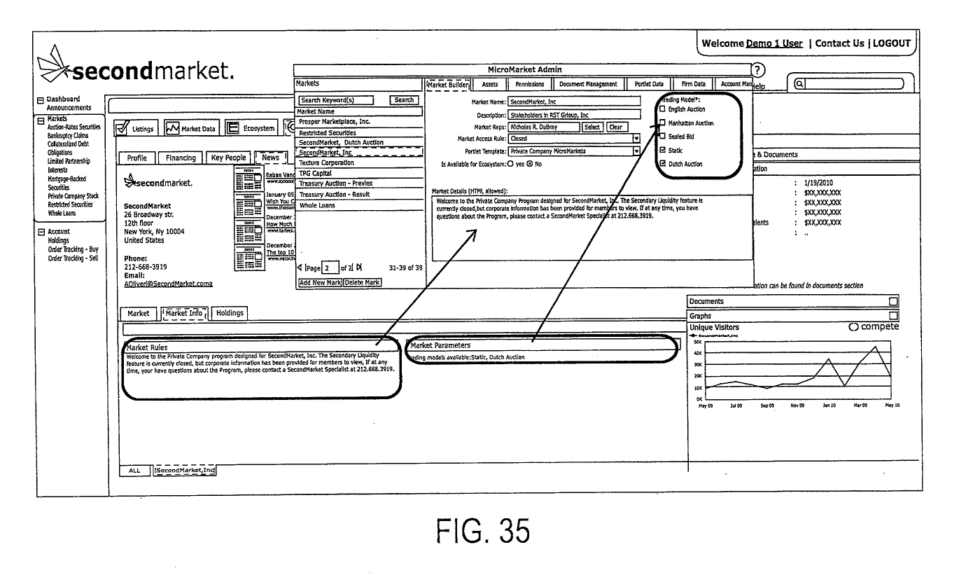

FIG. 35 illustrates MicroMarket Market Info.

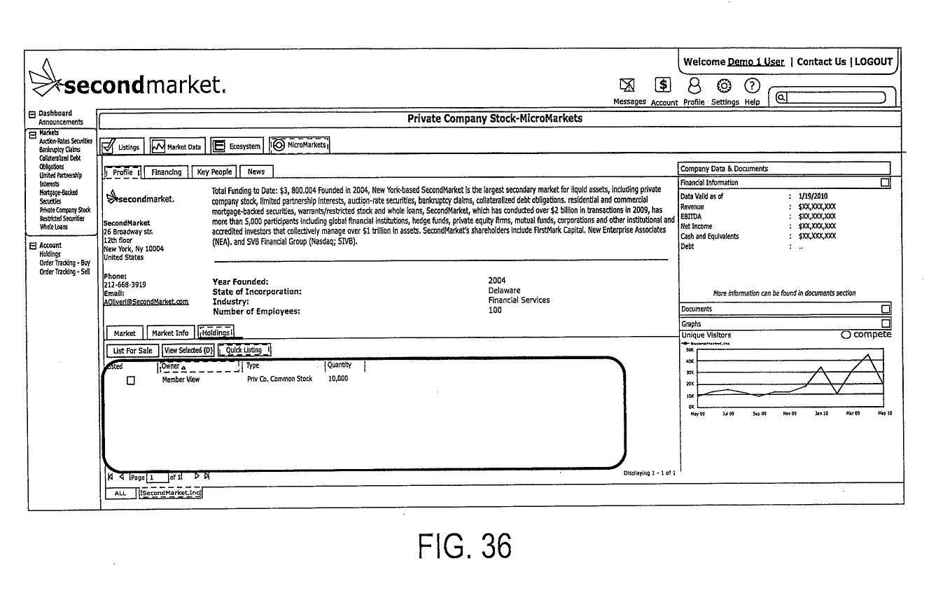

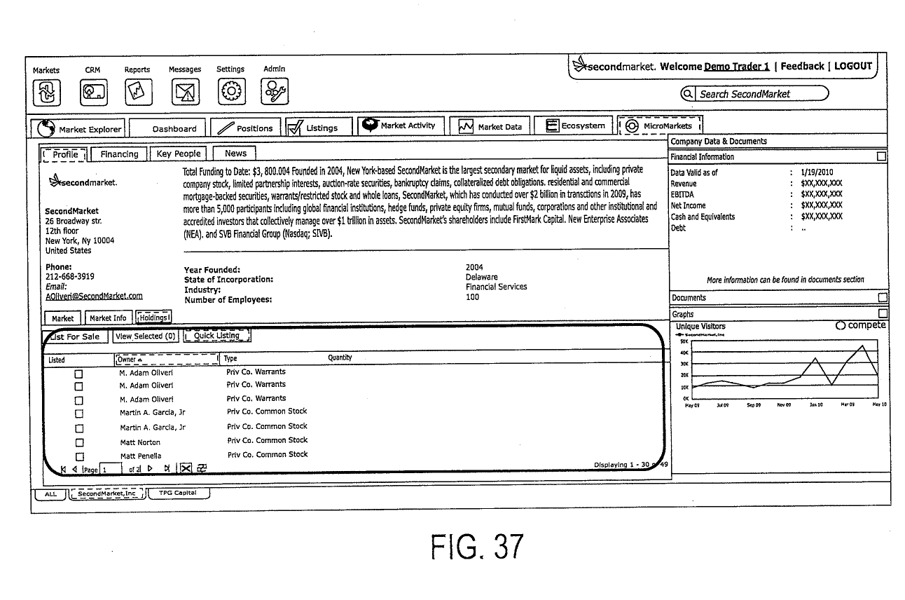

Holding tab on micromarket portlet (tab 7) displays user's holdings that can be listed in the current micromarket. Trader or external user with market admin rights can see holdings of all users that can be listed on micromarket. FIG. 36 illustrates MicroMarket Holdings (external user view). FIG. 37 illustrates MicroMarket Holdings (trader and market admin view).

Section C displays due-diligence materials, which include:
Key Financing Information
Documents

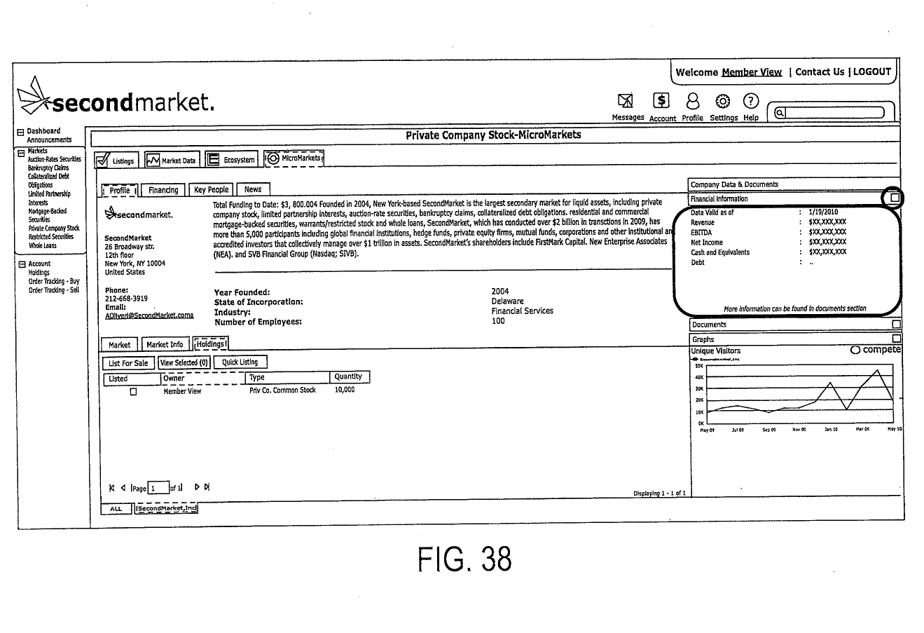

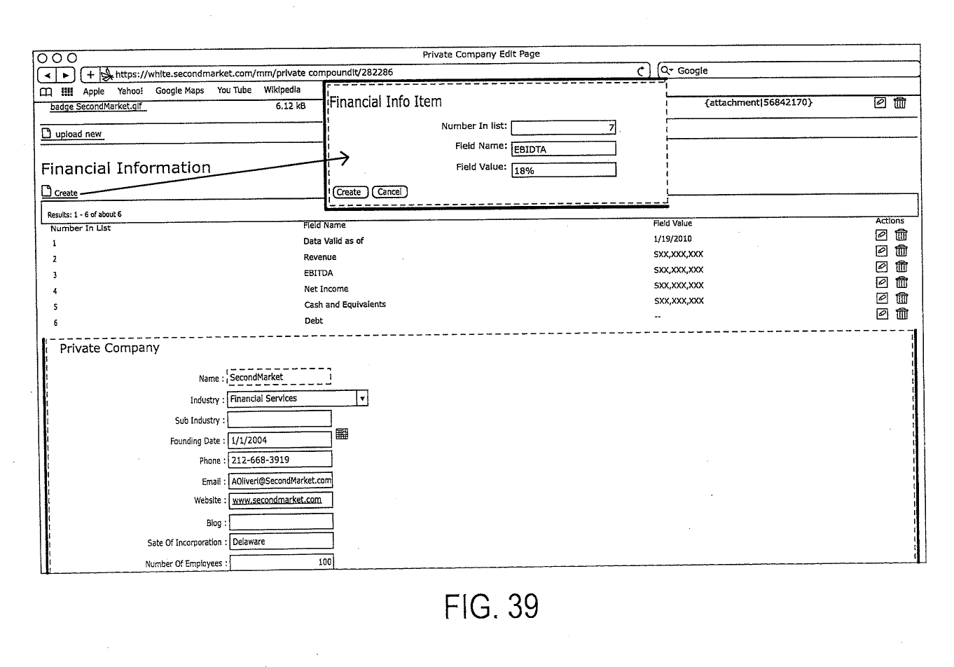

Key Financial Information can be the set of items in the ‘Label:Value” format. This can be managed from MM tool. FIG. 38 illustrates MicroMarket Financial Information. FIG. 39 illustrates Management of MicroMarket Financial Information.

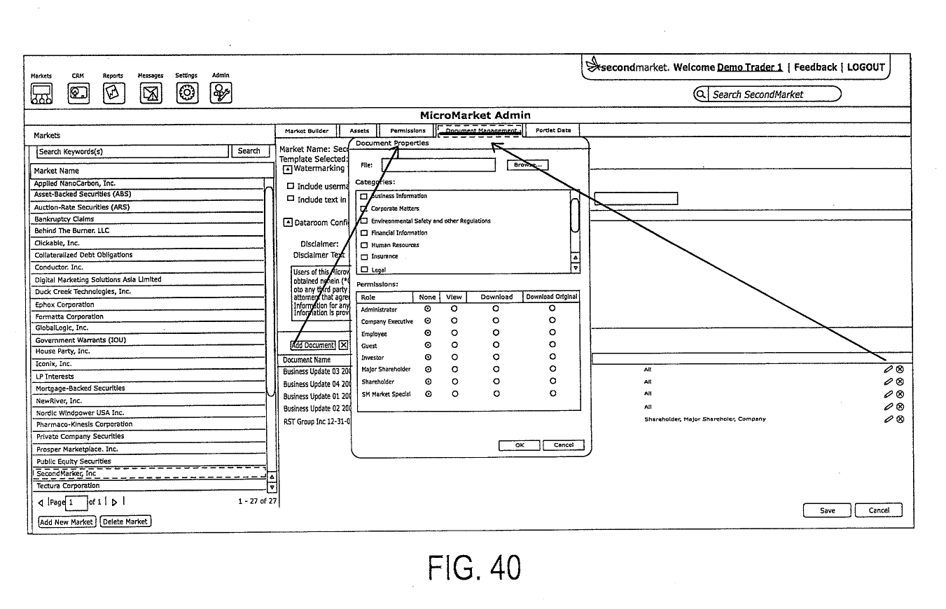

Documents section display documents for micromarket. Documents can be managed in Market Settings. FIG. 40 illustrates MicroMarket Dataroom.

Market Admin can manage documents in Document Management tab of market settings. When adding document, Market admin can indicate document categories and permissions. The list of categories can be predefined for private company micromarkets and can be as follows: Business Information, Corporate Matters, Environment Safety and Other Regulations, Financial Information, Human Resources, Insurance, Legal, Litigations Claims and Copyrights, Real and Personal Property, Significant Contracts and Agreements. System can be configured with different list of categories for each market.

Admin can assign document to multiple categories. Then these categories can be presented in MicroMarket portlet as folders.

Admin can also specify access permissions to the document. To do that admin use Roles. So user with particular role can have None, View, Download and Download Original permissions:
None—user will not see document at all
View—user will be able to open watermarked document in document viewer but do not download
Download—user will be able to download watermarked version of document in pdf format (event if original format was different (e.g. doc, xls)
Download Original—user will be able to download original (not watermarked) version of document in original format

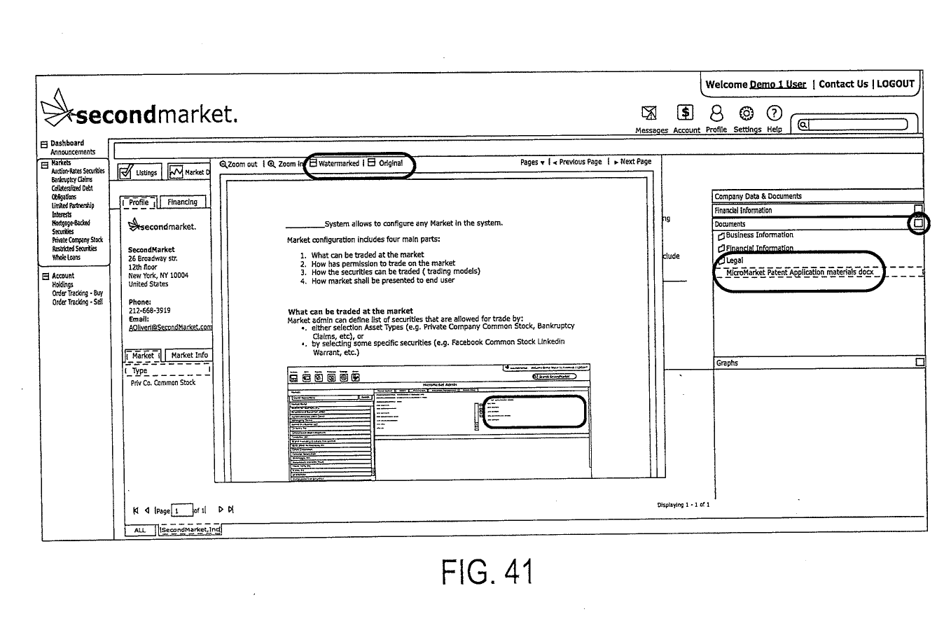

FIG. 41 illustrates Private Company MicroMarket Document in Document Viewer.

In addition to management documents Admin can configure:
Watermarking
Disclaimer

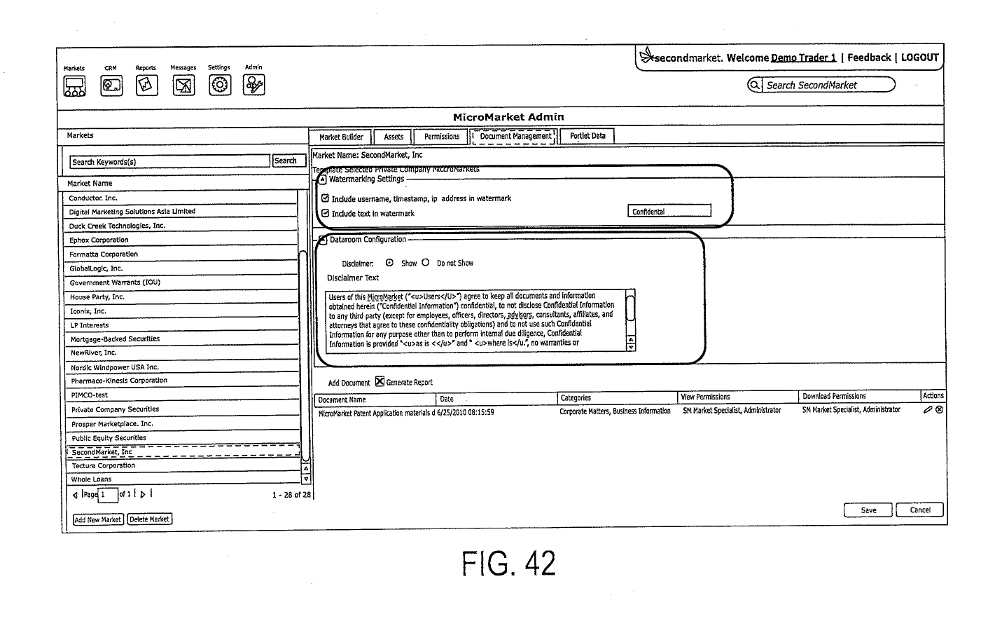

FIG. 42 illustrates Configuration of Watermarks and Disclaimers.

When configuring watermarks, admin can set to display:
User information, which includes username, timestamp, ip,
Watermark text

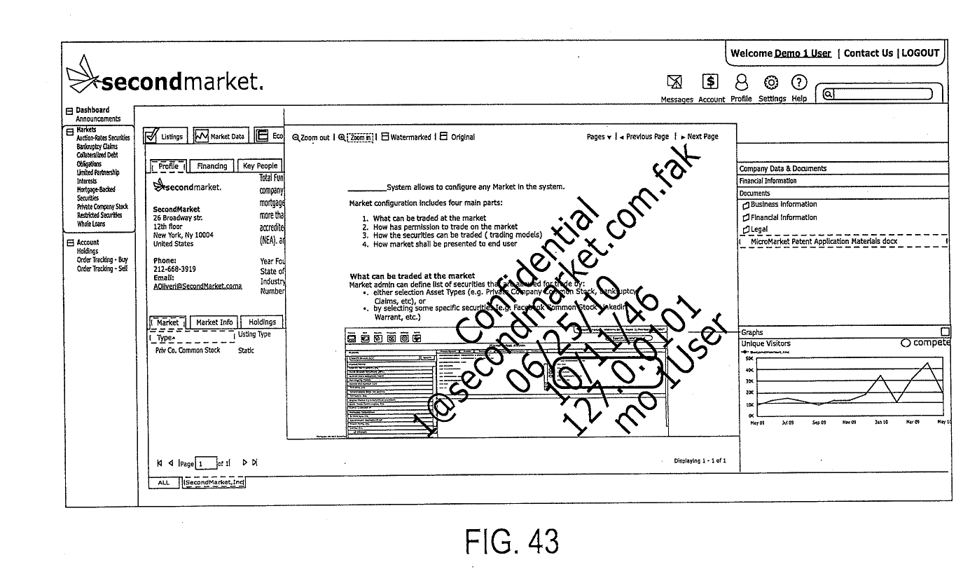

FIG. 43 illustrates Document Viewer with Watermarked document.

When configuring disclaimer, admin can set up:
Whether disclaimer shall be displayed
Disclaimer text

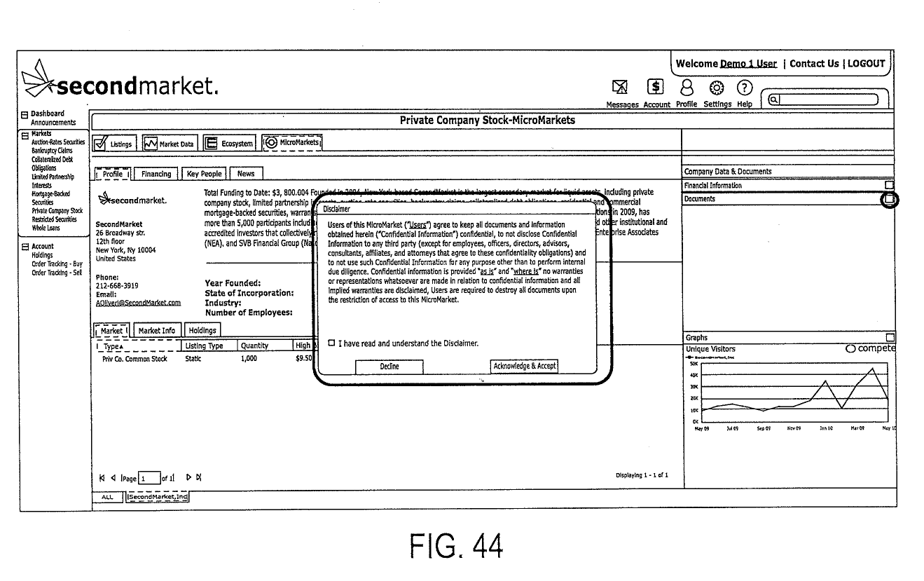

If disclaimer is configured to be displayed, user can get pop-up when he attempts to navigate to document section. FIG. 44 illustrates Disclaimer.

If user accepts disclaimer, document section can be expanded with document tree. If declines, document tree can not be shown to user and user can not able to access documents.

Once disclaimer is accepted, system can not display it again for the same micromarket within the same session, however if user logs out and logs in again, he can be required to accept disclaimer again.

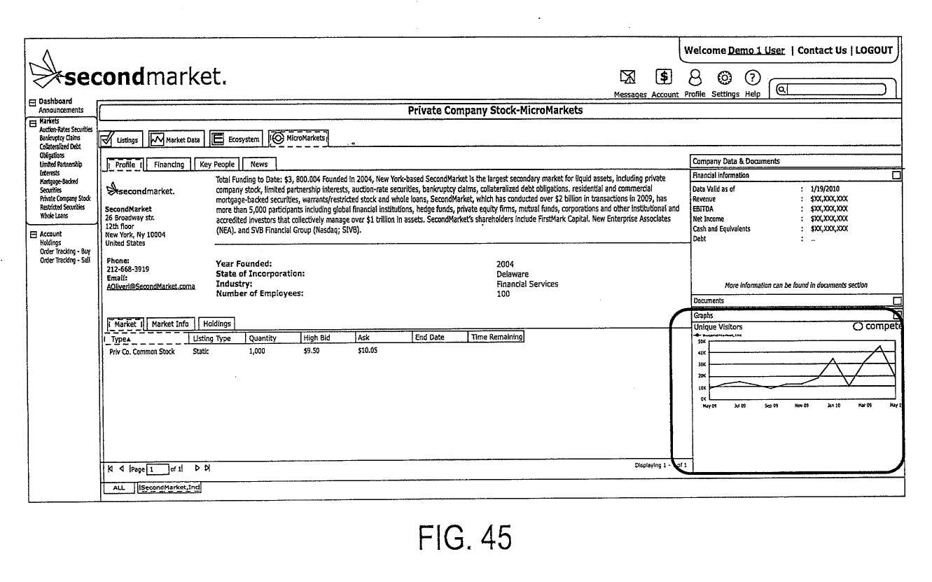

Graphs section displays 3rd party provider's graphs that are configured in MM tool. FIG. 45 illustrates Graphs.

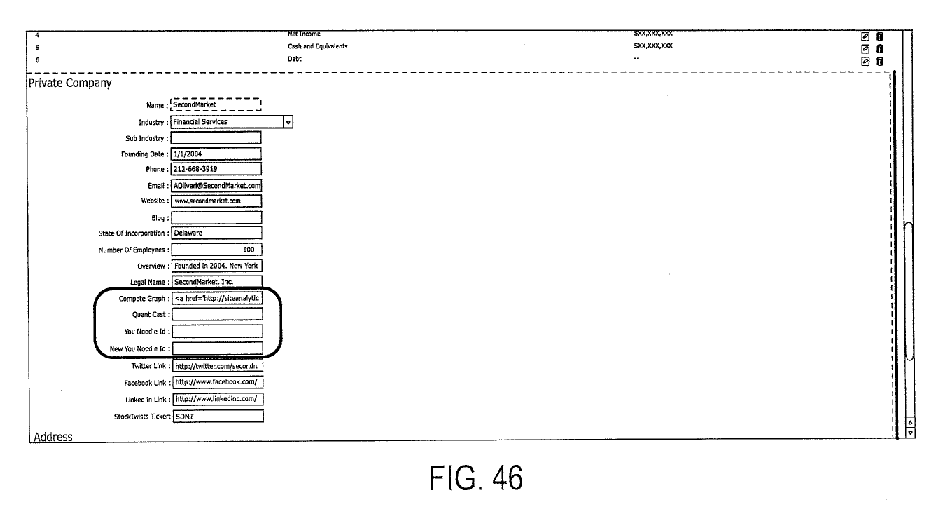

System can support graphs from Compete.com, younoodle.com, quantcast.com. FIG. 46 illustrates Configuring graphs. If more then one graph is configured, all of them can be displayed in Graph panel (one at a time) and change every X seconds (e.g., 5).

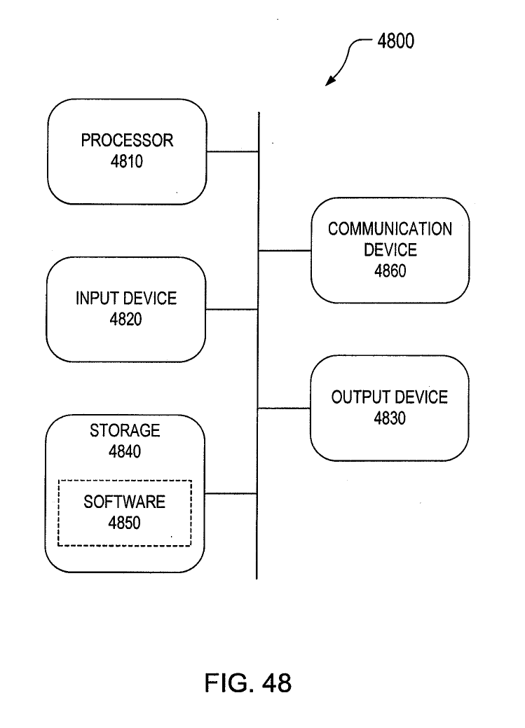

FIG. 48 shows a block diagram of an example of a computing device, which may generally correspond to server 100, issuer 110, holder 115, investor 120 and service provider 125. The form of computing device 4800 may be widely varied. For example, computing device 4800 can be a personal computer, workstation, server, handheld computing device, or any other suitable type of microprocessor-based device. Computing device 4800 can include, for example, one or more components including processor 4810, input device 4820, output device 4830, storage 4840, and communication device 4860. These components may be widely varied, and can be connected to each other in any suitable manner, such as via a physical bus, network line or wirelessly for example.

For example, input device 4820 may include a keyboard, mouse, touch screen or monitor, voice-recognition device, or any other suitable device that provides input. Output device 4830 may include, for example, a monitor, printer, disk drive, speakers, or any other suitable device that provides output.

Storage 4840 may include volatile and/or nonvolatile data storage, such as one or more electrical, magnetic or optical memories such as a RAM, cache, hard drive, CD-ROM drive, tape drive or removable storage disk for example. Communication device 4860 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 4850 can be stored in storage 4840 and executed by processor 4810, and may include, for example, programming that embodies the functionality described in the various embodiments of the present disclosure. The programming may take any suitable form. Software 4850 may include, for example, a combination of servers such as application servers and database servers.

Software 4850 can also be stored and/or transported within any computer-readable storage medium for use by or in connection with an instruction execution system, apparatus, or device, such as computing device 4800 for example, that can fetch instructions associated with the software from the instruction execution system, apparatus, or device and execute the instructions. In the context of this document, a computer-readable storage medium can be any medium, such as storage 4840 for example, that can contain or store programming for use by or in connection with an instruction execution system, apparatus, or device.

Software 4850 can also be propagated within any transport medium for use by or in connection with an instruction execution system, apparatus, or device, such as computing device 4800 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system comprising:
a server configured to
provide a first online environment configured to manage restricted holdings issued by a first issuer, and
restrict access to the first online environment to a membership authorized by the first issuer.

2. The system of claim 1, wherein the server is configured to
receive a request to grant a user access to the first online environment,
notify the first issuer of the access request, and
grant the access request in response to acceptance of the access request by the first issuer.

3. The system of claim 1, wherein the server is configured to
receive a request to grant a user access to the first online environment,
notify the first issuer of the access request,
receive an indication of acceptance of the access request by the first issuer,
perform a compliance check on the user to determine whether the user complies with one or more conditions associated with membership to the first online environment, and
grant the access request in response to a passing of the compliance check.

4. The system of claim 1, wherein the server is configured to
provide a second online environment configured to manage restricted holdings issued by a second issuer, and
restrict access to the second online environment to a membership authorized by the second issuer.

5. The system of claim 4, wherein the server is configured to
receive a request from the first issuer to grant a member of the first online environment access to the second online environment,
notify the second issuer of the access request, and
grant the access request in response to acceptance of the access request by the second issuer.

6. The system of claim 4, wherein the server is configured to
receive a request from the first issuer to grant a member of the first online environment access to the second online environment,
notify the second issuer of the access request,
receive an indication of acceptance of the access request by the second issuer,
perform a compliance check on the member to determine whether the member complies with one or more conditions associated with membership to the second online environment,
grant the access request in response to a passing of the compliance check.

7. The system of claim 1, wherein the server is configured to
track an event associated with a restriction associated with one or more of the restricted holdings,
determine whether the event is due, and
in response to a determination that the event is due, notifying a holder of the one or more of the restricted holdings that the event is due.

8. The system of claim 7, wherein the restriction comprises an option to buy shares of the one or more of the restricted holdings and the event comprises vesting of the option.

9. The system of claim 7, wherein the server is configured to
receive a request from the holder to act on the restriction in response to the notification that the event is due, and
process the request to act on the restriction.

10. The system of claim 1, wherein the server is configured to
receive a request to transfer one or more of the restricted holdings,
determine whether any restriction associated with the one or more of the restricted holdings prohibits the transfer, and
process the request to transfer in response to a determination that no restriction associated with the one or more of the restricted holdings prohibits the transfer.

11. The system of claim 10, wherein the server is configured to
determine whether a restriction associated with the one or more of the restricted holdings applies to the transfer, and
process the restriction in response to a determination that the restriction applies to the transfer.

12. The system of claim 11, wherein the restriction applying to the transfer comprises a right of first refusal.

13. A method comprising:
providing, by a server executed by a microprocessor, an online environment configured to manage restricted holdings issued by an issuer; and
restricting, by the server, access to the online environment to a membership authorized by the issuer.

14. The method of claim 13, comprising:
receiving, by the server, a request to grant a user access to the online environment,
notifying, by the server, the issuer of the access request, and
granting, by the server, the access request in response to acceptance of the access request by the issuer.

15. The method of claim 13, comprising:
tracking, by the server, an event associated with a restriction associated with one or more of the restricted holdings,
determining, by the server, whether the event is due, and
in response to a determination that the event is due, notifying, by the server, a holder of the one or more of the restricted holdings that the event is due.

16. The method of claim 15, comprising:
receiving, by the server, a request from the holder to act on the restriction in response to the notification that the event is due, and
processing, by the server, the request to act on the restriction.

17. The method of claim 13, comprising:
receiving, by the server, a request to transfer one or more of the restricted holdings,
determining, by the server, whether any restriction associated with the one or more of the restricted holdings prohibits the transfer, and
processing, by the server, the request to transfer in response to a determination that no restriction associated with the one or more of the restricted holdings prohibits the transfer.

18. The method of claim 17, comprising:
determining, by the server, whether a restriction associated with the one or more of the restricted holdings applies to the transfer, and
processing, by the server, the restriction in response to a determination that the restriction applies to the transfer.

19. A computer-readable storage medium storing instructions executable by a computer to:
provide a first online environment configured to manage restricted holdings issued by an issuer; and
restrict access to the first online environment to a membership authorized by the issuer.
